(19) United States
(12) Patent Application Publication
(10) Pub. No.: US 2025/0381775 A1
(43) Pub. Date: Dec. 18, 2025

(54) Liquid Ejecting Apparatus And Head Unit

(71) Applicant: SEIKO EPSON CORPORATION, Tokyo (JP)

(72) Inventors: Shunsuke KASAI, Minowa (JP); Masayuki KAWAKAMI, Matsumoto (JP)

(21) Appl. No.: 19/236,139

(22) Filed: Jun. 12, 2025

(30) Foreign Application Priority Data
Jun. 13, 2024 (JP) 2024-096075

(51) Int. Cl. B41J 2/045

(52) U.S. Cl. CPC B41J 2/04563; B41J 2/04508; B41J 2/04573; B41J 2/04581

(57) ABSTRACT

A liquid ejecting apparatus includes a drive circuit that outputs a drive signal, a print head that ejects a liquid by receiving the drive signal, and a temperature information output circuit that acquires a head temperature signal corresponding to a temperature of the print head, in which the temperature information output circuit includes a temperature information acquisition circuit that acquires, from the head temperature signal, temperature information corresponding to the temperature of the print head, and a timing control circuit that controls a timing at which the temperature information acquisition circuit acquires the temperature information, and the timing control circuit determines whether or not a voltage value of the drive signal is constant, and outputs a timing control signal for controlling, based on a determination result, the timing at which the temperature information acquisition circuit acquires the temperature information.

The present application is based on, and claims priority from JP Application Serial Number 2024-096075, filed Jun. 13, 2024, the disclosure of which is hereby incorporated by reference herein in its entirety.

### BACKGROUND

### 1. Technical Field

The present disclosure relates to a liquid ejecting apparatus and a head unit.

### 2. Related Art

A liquid ejecting apparatus whose configuration includes a print head, which has a piezoelectric element, a pressure chamber, and a nozzle communicating with the pressure chamber, is known. The print head changes a volume of the pressure chamber by driving the piezoelectric element to eject, from the nozzle, a liquid supplied to the pressure chamber. For the liquid ejecting apparatus including such a print head, a technique is known in which drive control is performed on the piezoelectric element based on a temperature of ink, which is stored in the print head, to implement ejection control suitable for the temperature of the ink.

For example, JP-A-2024-051474 discloses a technique in which a temperature detection section provided inside the print head detects a temperature of a print head, and a drive of a piezoelectric element is controlled based on the detected temperature of the print head.

However, from the viewpoint of detecting the temperature of the print head with high accuracy, there is room for improvement in the technique described in JP-A-2024-051474.

### SUMMARY

According to an aspect of the present disclosure, there is provided a liquid ejecting apparatus including: a drive circuit that outputs a drive signal; a print head that ejects a liquid by receiving the drive signal; and a temperature information output circuit that acquires a head temperature signal corresponding to a temperature of the print head, in which the temperature information output circuit includes a temperature information acquisition circuit that acquires, from the head temperature signal, temperature information corresponding to the temperature of the print head, and a timing control circuit that controls a timing at which the temperature information acquisition circuit acquires the temperature information, and the timing control circuit determines whether or not a voltage value of the drive signal is constant, and outputs a timing control signal for controlling, based on a determination result, the timing at which the temperature information acquisition circuit acquires the temperature information.

According to another aspect of the present disclosure, there is provided a head unit including: a print head that ejects a liquid by receiving a drive signal; and a temperature information output circuit that acquires a head temperature signal corresponding to a temperature of the print head, in which the temperature information output circuit includes a temperature information acquisition circuit that acquires, from the head temperature signal, temperature information corresponding to the temperature of the print head, and a timing control circuit that controls a timing at which the temperature information acquisition circuit acquires the temperature information, and the timing control circuit determines whether or not a voltage value of the drive signal is constant, and outputs a timing control signal for controlling, based on a determination result, the timing at which the temperature information acquisition circuit acquires the temperature information.

### BRIEF DESCRIPTION OF THE DRAWINGS

FIG. 1 is a diagram showing a schematic configuration of a liquid ejecting apparatus.

FIG. 2 is an exploded perspective view of a structure of a print head.

FIG. 3 is a plan view of the print head when viewed along a Z axis.

FIG. 4 is a sectional view of the print head taken along a line IV-IV shown in FIG. 3.

FIG. 5 is a main portion detailed view of details of main portions in FIG. 4.

FIG. 6 is a sectional view of the print head taken along a line VI-VI shown in FIG. 3.

FIG. 7 is a diagram showing a functional configuration of the liquid ejecting apparatus.

FIG. 8 is a diagram showing an example of a signal waveform of a drive signal.

FIG. 9 is a diagram showing a configuration of a drive signal selection circuit.

FIG. 10 is a table showing an example of decoding contents in a decoder.

FIG. 11 is a diagram showing a configuration of a selection circuit.

FIG. 12 is a diagram for describing an operation of the drive signal selection circuit.

FIG. 13 is a diagram showing an example of a configuration of a temperature detection circuit.

FIG. 14 is a diagram showing an example of a configuration of a temperature information output circuit.

FIG. 15 is a diagram showing an example of a configuration of a comparison circuit and a timing control circuit.

FIG. 16 is a diagram showing an example of an operation of the liquid ejecting apparatus.

FIG. 17 is a diagram showing an example of an operation of the temperature information output circuit.

FIG. 18 is a diagram showing an example of the operation of the temperature information output circuit.

### DESCRIPTION OF EMBODIMENTS

Hereinafter, preferred embodiments of the present disclosure will be described with reference to drawings. The drawings are used for convenience of description. The embodiments to be described below do not inappropriately limit the contents of the present disclosure described in the claims. Further, not all of configurations to be described below are necessarily essential components of the present disclosure.

### 1. Schematic Configuration of Liquid Ejecting Apparatus

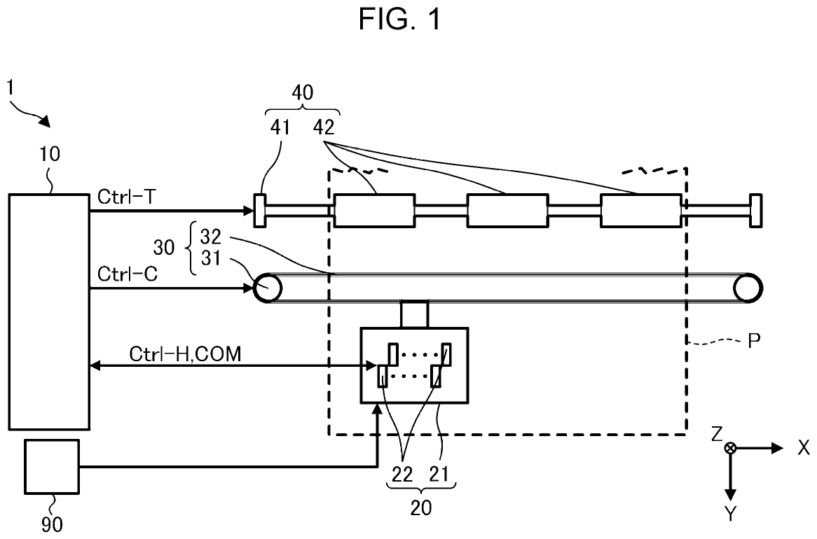

FIG. 1 is a diagram showing a schematic configuration of a liquid ejecting apparatus 1. The liquid ejecting apparatus 1 according to the present embodiment is a so-called serial printing-type ink jet printer in which a carriage 21 equipped with a print head 22, which ejects ink as an example of a liquid, reciprocates along a scanning axis and ejects the ink to a medium P that is transported along a transport direction to form a desired image on the medium P. Further, any printing target, such as printing paper, a resin film, or a cloth, may be used as the medium P in the liquid ejecting apparatus 1. The liquid ejecting apparatus 1 is not limited to the serial printing-type ink jet printer, and may be a line printing-type ink jet printer. Further, the liquid ejecting apparatus 1 is not limited to the ink jet printer, and may be a coloring material ejecting apparatus used for manufacturing a color filter for a liquid crystal display or the like, an electrode material ejecting apparatus used for forming an electrode for an organic EL display, a field emission display (FED), or the like, a bioorganic substance ejecting apparatus used for manufacturing a biochip, a stereolithography apparatus, a textile printing apparatus, and the like.

The following description will be made by using an X axis, a Y axis, and a Z axis, which are three spatial axes orthogonal to each other. Further, in the following description, when an orientation in a direction along each of the X axis, the Y axis, and the Z axis is specified, a tip side of an arrow indicating the direction along the X axis illustrated in the drawings is referred to as a +X side and a starting point side thereof is referred to as a −X side, a tip side of an arrow indicating the direction along the Y axis illustrated in the drawings is referred to as a +Y side and a starting point side thereof is referred to as a −Y side, and a tip side of an arrow indicating the direction along the Z axis illustrated in the drawings is referred to as a +Z side and a starting point side thereof is referred to as a −Z side.

As shown in FIG. 1, the liquid ejecting apparatus 1 includes a control unit 10, a head unit 20, a moving unit 30, a transport unit 40, and an ink container 90.

The ink container 90 stores a plurality of types of ink to be ejected to the medium P. An ink cartridge, a bag-shaped ink pack made of a flexible film, an ink-refillable ink tank, and the like may be used as the ink container 90 storing such ink.

The control unit 10 includes a processing circuit, such as a central processing unit (CPU) or a field programmable gate array (FPGA), and a storage circuit, such as a semiconductor memory, and controls each element of the liquid ejecting apparatus 1 including the head unit 20.

The head unit 20 includes the carriage 21 and a plurality of print heads 22. The carriage 21 is fixed to an endless belt 32 included in the moving unit 30, which will be described below. The plurality of print heads 22 are equipped on the carriage 21. Further, a control signal Ctrl-H and a drive signal COM, which are output by the control unit 10, are input to each of the plurality of print heads 22. Furthermore, the ink stored in the ink container 90 is supplied to each of the plurality of print heads 22 via a tube (not illustrated) or the like. The print head 22 ejects the ink supplied from the ink container 90 based on the input control signal Ctrl-H and drive signal COM. In this case, the direction that is along the Z axis in which the print head 22 ejects the ink and is toward the +Z side from the −Z side along the Z axis may be referred to as an ejection direction.

The moving unit 30 includes a carriage motor 31 and the endless belt 32. The carriage motor 31 operates based on a control signal Ctrl-C input from the control unit 10. The endless belt 32 extends along the X axis and rotates according to the operation of the carriage motor 31. Accordingly, the carriage 21 fixed to the endless belt 32 moves along the X axis. That is, the moving unit 30 causes the plurality of print heads 22 equipped on the carriage 21 to reciprocate along the X axis. In the following description, the direction along the X axis in which the plurality of print heads 22 equipped on the carriage 21 move may be referred to as a scanning direction.

The transport unit 40 includes a transport motor 41 and transport rollers 42. The transport motor 41 operates based on a control signal Ctrl-T input from the control unit 10. The transport rollers 42 rotate according to the operation of the transport motor 41 in a state where the medium P is pinched therebetween. Accordingly, the medium P pinched between the transport rollers 42 is transported from the −Y side toward the +Y side along the Y axis. That is, the transport unit 40 causes the medium P to be transported from the −Y side toward the +Y side along the Y axis. In the following description, the direction from the −Y side toward the +Y side in which the medium P is transported may be referred to as the transport direction.

In the liquid ejecting apparatus 1 configured as described above, the moving unit 30 controls the reciprocation of the carriage 21 along the scanning direction, and the transport unit 40 controls the transport of the medium P in the direction along the transport direction. The print head 22 equipped on the carriage 21 ejects the ink in conjunction with the reciprocation of the carriage 21 along the scanning direction and the transport of the medium P in the transport direction. As a result, the ink ejected by the print head 22 can be landed on any surface of the medium P, and thus a desired image is formed at the medium P.

### 2. Schematic Structure of Print Head

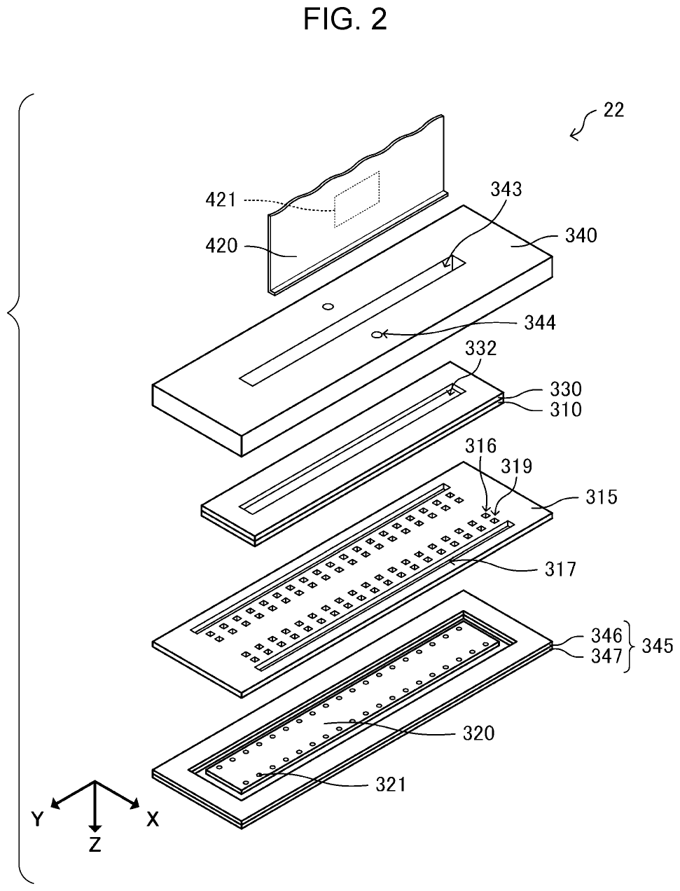

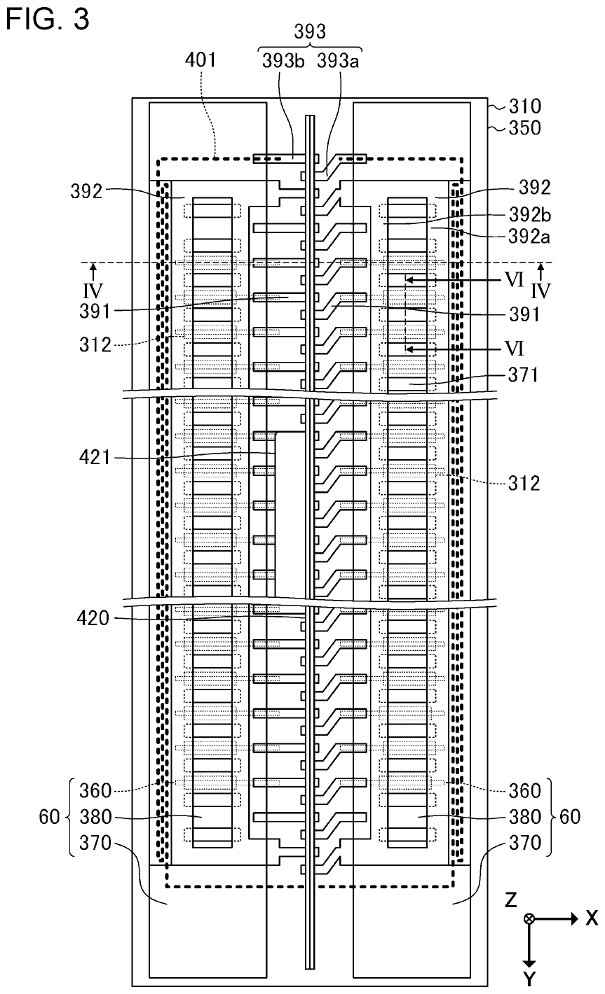

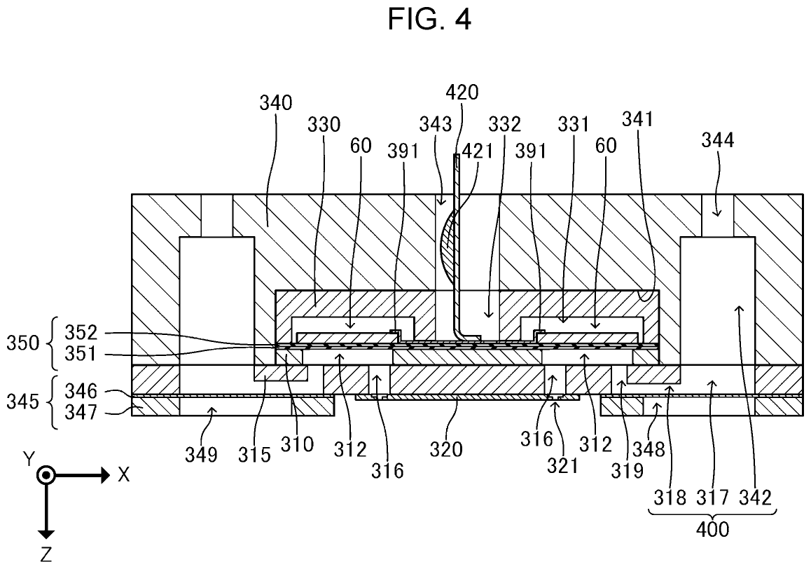

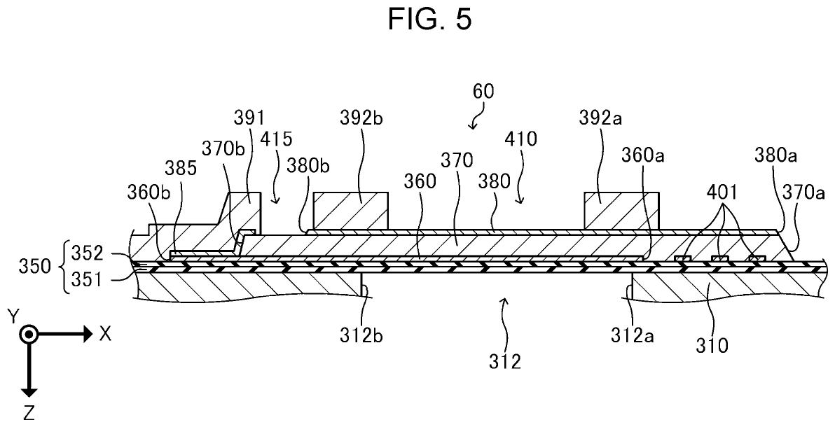

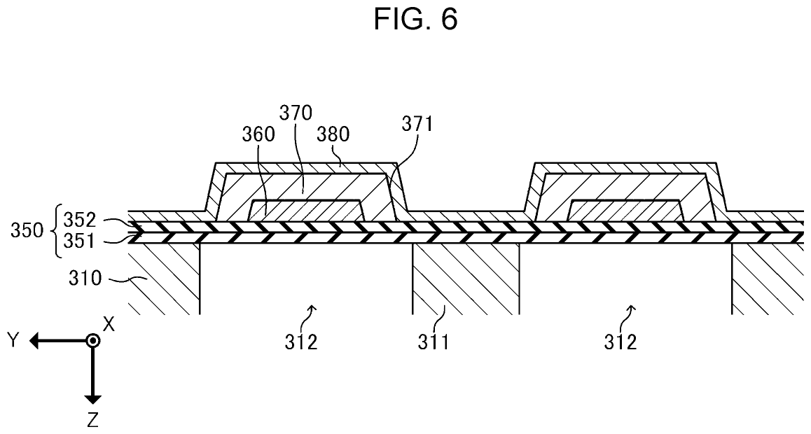

Next, an example of a structure of the print head 22 included in the head unit 20 will be described. FIG. 2 is an exploded perspective view of the structure of the print head 22, FIG. 3 is a plan view of the print head 22 when viewed along the Z axis, FIG. 4 is a sectional view of the print head 22 taken along a line IV-IV shown in FIG. 3, FIG. 5 is a main portion detailed view of details of main portions in FIG. 4, and FIG. 6 is a sectional view of the print head 22 taken along a line VI-VI shown in FIG. 3. In FIG. 3, a peripheral configuration of a pressure chamber substrate 310 is mainly illustrated, and a protective substrate 330, a case member 340, and the like are not illustrated. In FIG. 4, a configuration of a piezoelectric element 60 is illustrated in a simplified manner.

As shown in FIG. 2, the print head 22 includes the pressure chamber substrate 310, a communication plate 315, a nozzle plate 320, a compliance substrate 345, the protective substrate 330, the case member 340, a wiring substrate 420, and a vibration plate 350 and the piezoelectric element 60, which will be described below.

The pressure chamber substrate 310 is formed of, for example, a silicon substrate, a glass substrate, an SOI substrate, or various ceramic substrates. As shown in FIG. 3, the pressure chamber substrate 310 is formed, along the X axis, with two pressure chamber columns in which a plurality of pressure chambers 312 are provided side by side along the Y axis. In this case, the plurality of pressure chambers 312 are disposed on a straight line along the Y axis such that positions of the pressure chambers 312 forming each pressure chamber column along the X axis are the same. The pressure chambers 312 adjacent to each other along the Y axis are partitioned by partition walls 311, as shown in FIG. 6. The disposition of the pressure chambers 312 on the pressure chamber substrate 310 is not limited to the above disposition. For example, the plurality of pressure chambers 312 may be disposed on a straight line along the Y axis such that the positions of the pressure chambers 312 forming each pressure chamber column along the X axis are different. In the following description, among the two pressure chamber columns formed at the pressure chamber substrate 310, a pressure chamber column located on the +X side may be referred to as a first pressure chamber column, and a pressure chamber column located on the −X side of the first pressure chamber column may be referred to as a second pressure chamber column.

Further, the pressure chamber 312 is formed in a so-called rectangular shape in which a length in the direction along the X axis is longer than a length in the direction along the Y axis in plan view when viewed from the +Z side. Of course, a shape of the pressure chamber 312 in plan view from the +Z side is not limited to the rectangular shape, and may be a parallel quadrilateral shape, a polygonal shape, a circular shape, an oval shape, or the like. The oval shape refers to a shape in which both end portions in a longitudinal direction are semicircular with the rectangular shape as a base, and includes a rounded rectangular shape, an elliptical shape, an egg shape, and the like.

As shown in FIG. 2, the communication plate 315, the nozzle plate 320, and the compliance substrate 345 are laminated on the +Z side of the pressure chamber substrate 310.

As shown in FIGS. 2, 4, and 5, the communication plate 315 is formed with a nozzle communication path 316, a first manifold portion 317, a second manifold portion 318, and a supply communication path 319. The first manifold portion 317 penetrates the communication plate 315 in the direction along the Z axis. The second manifold portion 318 communicates with the first manifold portion 317 and is open on a surface of the communication plate 315 on the +Z side without penetrating the communication plate 315 in the direction along the Z axis. Such first manifold portion 317 and second manifold portion 318 configure a part of a manifold 400 serving as a common liquid chamber in which the plurality of pressure chambers 312 communicate with each other. The supply communication path 319 is independently provided in correspondence with each of the plurality of pressure chambers 312, and communicates one end portion of the corresponding pressure chamber 312 in the direction along the X axis with the second manifold portion 318. Accordingly, the ink stored in the manifold 400 is supplied to each pressure chamber 312. Further, the nozzle communication path 316 communicates the pressure chamber 312 with a nozzle 321.

A silicon substrate, a glass substrate, an SOI substrate, various ceramic substrates, a metal substrate, or the like may be used as such a communication plate 315. Further, an example of the metal substrate includes a stainless steel substrate. The communication plate 315 is preferably formed by using a material having a thermal expansion coefficient substantially the same as a thermal expansion coefficient of the pressure chamber substrate 310. Accordingly, even when temperatures of the pressure chamber substrate 310 and the communication plate 315 change, a risk of warpage of the pressure chamber substrate 310 and the communication plate 315 due to a difference in the thermal expansion coefficient can be reduced.

The nozzle plate 320 is located on a side of the communication plate 315 opposite to the pressure chamber substrate 310, that is, on the surface of the communication plate 315 on the +Z side. The nozzle plate 320 is formed with a plurality of nozzles 321 that communicate with respective pressure chambers 312 via the nozzle communication paths 316. Specifically, the nozzle plate 320 is formed, along the X axis, with two nozzle columns in which the plurality of nozzles 321 are provided side by side along the Y axis. The two nozzle columns correspond to the first pressure chamber column and the second pressure chamber column, respectively. Further, the plurality of nozzles 321 are disposed on a straight line along the Y axis such that positions of the nozzles 321 forming each nozzle column along the X axis are the same. The disposition of the nozzles 321 on the nozzle plate 320 is not limited to the above disposition. For example, the plurality of nozzles 321 may be disposed on a straight line along the Y axis such that the positions of the nozzles 321 forming each nozzle column along the X axis are different. That is, the print head 22 of the present embodiment has the plurality of nozzles 321, and the plurality of nozzles 321 are located side by side along the Y axis in the nozzle plate 320.

A material of such a nozzle plate 320 is not particularly limited. For example, a silicon substrate, a glass substrate, an SOI substrate, various ceramic substrates, a metal substrate, or an organic material such as a polyimide resin may be used. Further, an example of the metal substrate used as the material of the nozzle plate 320 includes a stainless steel substrate. However, the nozzle plate 320 is preferably formed by using a material having a thermal expansion coefficient substantially the same as a thermal expansion coefficient of the communication plate 315. Accordingly, when temperatures of the nozzle plate 320 and the communication plate 315 change, a risk of warpage of the nozzle plate 320 and the communication plate 315 due to a difference in the thermal expansion coefficient can be reduced.

The compliance substrate 345 is located on a side of the communication plate 315 opposite to the pressure chamber substrate 310, that is, on the surface of the communication plate 315 on the +Z side, together with the nozzle plate 320. The compliance substrate 345 is located around the nozzle plate 320 and seals openings of the first manifold portion 317 and the second manifold portion 318, which are formed in the communication plate 315, on the +Z side. The compliance substrate 345 includes a sealing film 346 formed of a flexible thin film and a fixed substrate 347 made of a hard material such as metal. Further, an opening portion 348 obtained by completely removing the fixed substrate 347 in a thickness direction is formed in a region of the fixed substrate 347 facing the manifold 400. That is, one surface of the manifold 400 is a compliance portion 349 sealed only with the flexible sealing film 346.

On the other hand, the vibration plate 350 and the piezoelectric element 60 are laminated on a side of the pressure chamber substrate 310 opposite to the nozzle plate 320 and the like, that is, on the −Z side of the pressure chamber substrate 310. In other words, the vibration plate 350 is located on the +Z side of the piezoelectric element 60 in the direction along the Z axis, and the pressure chamber substrate 310 is located on the +Z side of the vibration plate 350 in the direction along the Z axis.

Furthermore, the protective substrate 330 having substantially the same size as the pressure chamber substrate 310 is located on the −Z side of the pressure chamber substrate 310, and is bonded by a bonding agent or the like. The protective substrate 330 is formed with a holding portion 331, which is a space for protecting the piezoelectric element 60. The holding portion 331 is provided independently for each column of the piezoelectric elements 60 provided side by side along the Y axis. That is, the protective substrate 330 is formed with two holding portions 331 aligned along the X axis. Further, the protective substrate 330 is located between the two holding portions 331, which are aligned along the X axis, and is formed with a through-hole 332 penetrating in the direction along the Z axis.

Further, the case member 340 that defines the manifold 400 communicating with the plurality of pressure chambers 312, together with the pressure chamber substrate 310, is fixed on the protective substrate 330. The case member 340 has substantially the same shape as that of the communication plate 315 described above in plan view from the −Z side, and is bonded to the protective substrate 330 and is also bonded to the communication plate 315 described above.

The case member 340 is formed with an accommodation portion 341. The accommodation portion 341 is a space having a depth enabling the pressure chamber substrate 310 and the protective substrate 330 to be accommodated, and has an opening wider than a surface of the protective substrate 330 bonded to the pressure chamber substrate 310 on a protective substrate 330 side of the case member 340. An opening surface of the accommodation portion 341 on a nozzle plate 320 side is sealed by the communication plate 315 in a state where the accommodation portion 341 accommodates the pressure chamber substrate 310 and the protective substrate 330.

Further, the case member 340 is formed with a third manifold portion 342 defined on each of both outer sides of the accommodation portion 341 in the direction along the X axis. The manifold 400 is configured by the third manifold portion 342, which is provided in the case member 340, and the first manifold portion 317 and the second manifold portion 318, which are provided in the communication plate 315. Such a manifold 400 is continuously provided along the Y axis, and the supply communication paths 319 communicating respective pressure chambers 312 with respective manifolds 400 are disposed side by side in the direction along the Y axis.

Further, the case member 340 is formed with a supply port 344 that communicates with the manifold 400 to supply the ink to each of the manifolds 400. Furthermore, the case member 340 is formed with a coupling port 343 that communicates with the through-hole 332 of the protective substrate 330 and into which the wiring substrate 420 is inserted.

Such a print head 22 takes in, from the supply port 344, the ink stored in the ink container 90 via an ink tube (not illustrated) or the like. Accordingly, a path from the manifold 400 of the print head 22 to the nozzle 321 is filled with the ink. Thereafter, a signal based on the drive signal COM is supplied from an integrated circuit 421 to each of the piezoelectric elements 60 corresponding to the pressure chamber 312. Accordingly, the piezoelectric element 60 is bent and deformed, and the vibration plate 350 is bent and deformed due to the deformation of the piezoelectric element 60. Due to the deformation of the vibration plate 350, an internal pressure of each pressure chamber 312 changes, and the ink is ejected from each nozzle 321 according to the change in the internal pressure.

Next, a configuration that includes the vibration plate 350 and the piezoelectric element 60 and is formed by lamination on the −Z side of the pressure chamber substrate 310 will be described in detail. The print head 22 has an individual lead electrode 391, a common lead electrode 392, a lead electrode for measurement 393, and a resistance wiring 401, in addition to the vibration plate 350 and the piezoelectric element 60 described above, as the configuration laminated on the −Z side of the pressure chamber substrate 310.

As shown in FIGS. 4 to 6, the vibration plate 350 has an elastic film 351 made of a silicon oxide provided on a pressure chamber substrate 310 side, and an insulator film 352 made of zirconium oxide film provided on the elastic film 351. Further, a liquid flow path including the pressure chamber 312 formed in the pressure chamber substrate 310 described above is formed by anisotropically etching the pressure chamber substrate 310 from a surface of the pressure chamber substrate 310 on the +Z side. The vibration plate 350 is located to seal an opening of the pressure chamber substrate 310 on a surface of the vibration plate 350 on the +Z side. That is, a surface of the liquid flow path such as the pressure chamber 312 formed in the pressure chamber substrate 310 on the −Z side is configured of the vibration plate 350 including the elastic film 351. The configuration of the vibration plate 350 is not particularly limited. For example, the vibration plate 350 may be configured of only any one of the elastic film 351 and the insulator film 352, or may be configured by including another film other than the elastic film 351 and the insulator film 352. An example of another film configuring the vibration plate 350 includes a film such as silicon or silicon nitride.

The piezoelectric element 60 has an electrode 360, a piezoelectric body 370, and an electrode 380 sequentially laminated from the +Z side, which is a vibration plate 350 side, toward the −Z side. That is, the piezoelectric element 60 includes the electrode 360, the electrode 380, and the piezoelectric body 370, and the piezoelectric body 370 is provided between the electrode 360 and the electrode 380 in the direction along the Z axis in which the electrode 360, the electrode 380, and the piezoelectric body 370 are laminated. Such a piezoelectric element 60 functions as a piezoelectric actuator that causes a pressure change in the pressure chamber 312.

Specifically, both the electrode 360 and the electrode 380 are electrically coupled to the wiring substrate 420. The signal based on the drive signal COM, which is output by the integrated circuit 421 mounted on the wiring substrate 420, is supplied to one of the electrodes 360 and 380, and a signal having a reference potential propagating through the wiring substrate 420 is supplied to the other of the electrodes 360 and 380. Accordingly, in the piezoelectric body 370, a potential difference is generated between the signal based on the drive signal COM supplied from the integrated circuit 421 and the signal having the reference potential. Due to the potential difference generated between the electrode 360 and the electrode 380, the piezoelectric body 370 is deformed. The vibration plate 350 is deformed or vibrated in accordance with the deformation of the piezoelectric body 370, and a volume of the pressure chamber 312 changes due to the deformation or vibration of the vibration plate 350. The change in the internal pressure due to the change in the volume of the pressure chamber 312 is applied to the ink accommodated in the pressure chamber 312, and thus the ink is ejected from the nozzle 321 via the nozzle communication path 316. The following description will be made on the assumption that the signal based on the drive signal COM output by the integrated circuit 421 mounted on the wiring substrate 420 is supplied to the electrode 360 and the signal having the reference potential propagating through the wiring substrate 420 is supplied to the electrode 380.

In the following description, when the potential difference is generated between the electrode 360 and the electrode 380 in the piezoelectric element 60, a portion where piezoelectric distortion occurs in the piezoelectric body 370 may be referred to as an active portion 410, and a portion where the piezoelectric distortion does not occur in the piezoelectric body 370 may be referred to as a non-active portion 415. That is, in the piezoelectric element 60, a portion where the piezoelectric body 370 is interposed between the electrode 360 and the electrode 380 corresponds to the active portion 410, and a portion where the piezoelectric body 370 is not interposed between the electrode 360 and the electrode 380 corresponds to the non-active portion 415. Further, in the following description, when the piezoelectric element 60 is driven, a portion that is displaced in the direction along the Z axis may be referred to as a flexible portion, and a portion that is not displaced in the direction along the Z axis may be referred to as a non-flexible portion. That is, in the piezoelectric element 60, a portion that faces the pressure chamber 312 in the direction along the Z axis corresponds to the flexible portion, and a portion on an outer side of the pressure chamber 312 corresponds to the non-flexible portion. The active portion 410 may be referred to as an activated portion, and the non-active portion 415 may be referred to as a non-activated portion.

In general, any one of the electrodes 360 and 380 located in the active portion 410 is configured as an individual electrode that is independent for each active portion 410, and the other is configured as a common electrode that is common to the active portion 410. The following description will be made on the assumption that the electrode 360 to which the signal based on the drive signal COM output by the integrated circuit 421 is supplied is the individual electrode, and the electrode 380 to which the signal having the reference potential propagating through the wiring substrate 420 is supplied is the common electrode.

Specifically, the electrode 360 is located on the +Z side of the piezoelectric body 370, is separated for each pressure chamber 312, and configures the individual electrode that is independent for each active portion 410. That is, the electrode 360 is individually provided in correspondence with the plurality of pressure chambers 312. Further, the electrode 360 is formed with a width smaller than a width of the pressure chamber 312 in the direction along the Y axis. That is, an end portion of the electrode 360 is located on an inner side of a region facing the pressure chamber 312 in a direction along the Y axis. Further, an end portion 360a on the +X side of the electrode 360 and an end portion 360b on the −X side thereof are located on an outer side of the pressure chamber 312, respectively. For example, as shown in FIG. 5, in the first pressure chamber column, the end portion 360a is located on the +X side of the end portion 312a, which is on the +X side of the pressure chamber 312, and the end portion 360b is located on the −X side of the end portion 312b, which is on the −X side of the pressure chamber 312.

A material of such an electrode 360 is not particularly limited. For example, a conductive material such as a metal such as platinum (Pt), iridium (Ir), gold (Au), and titanium (Ti), or a conductive metal oxide such as indium tin oxide abbreviated as ITO may be used, or a material in which a plurality of materials such as platinum (Pt), iridium (Ir), gold (Au), and titanium (Ti) are laminated may be used. The description will be made on the assumption that the electrode 360 of the present embodiment is platinum (Pt).

Further, as shown in FIG. 3, the piezoelectric body 370 is continuously provided over the direction along the Y axis with a length of the piezoelectric body 370 in the direction along the X axis as a predetermined length. That is, the piezoelectric body 370 is continuously provided with a predetermined thickness along the direction in which the pressure chambers 312 are provided side by side. A thickness of such a piezoelectric body 370 is not particularly limited. For example, the piezoelectric body 370 is formed with a thickness of about 1,000 nanometers to 4,000 nanometers.

Further, as shown in FIG. 5, the length of the piezoelectric body 370 in the direction along the X axis is larger than a length of the pressure chamber 312 in the direction along the X axis, which is a longitudinal direction of the pressure chamber 312. Thus, the piezoelectric body 370 extends to the outer side of the pressure chamber 312 on both sides of the pressure chamber 312 in the direction along the X axis. As described above, with the extension of the piezoelectric body 370 to the outer side of the pressure chamber 312 in the direction along the X axis, the strength of the vibration plate 350 is improved. Therefore, with drive of the active portion 410, a risk of generation of a crack or the like in the vibration plate 350 or the piezoelectric element 60 is reduced.

Further, for example, as shown in FIG. 5, in the first pressure chamber column, an end portion 370a of the piezoelectric body 370 on the +X side is located on the +X side that is an outer side of the end portion 360a of the electrode 360. That is, the end portion 360a of the electrode 360 is covered with the piezoelectric body 370. On the other hand, an end portion 370b of the piezoelectric body 370 on the −X side is located on the +X side that is an inner side of the end portion 360b of the electrode 360. That is, the end portion 360b of the electrode 360 is not covered with the piezoelectric body 370.

Further, as shown in FIGS. 3 and 6, the piezoelectric body 370 is formed with a groove portion 371, which is a portion having a thickness thinner than that of other regions, in correspondence with each partition wall 311. The groove portion 371 of the present embodiment is formed by completely removing the piezoelectric body 370 in the direction along the Z axis. That is, the fact that the piezoelectric body 370 has the portion having the thinner thickness than other regions is not limited to a case where the piezoelectric body 370 is formed to be thinner than other portions on a bottom surface of the groove portion 371, and includes a case where the piezoelectric body 370 is completely removed in the direction along the Z axis. Further, a length of the groove portion 371 in a direction along the Y axis, that is, a width of the groove portion 371 is the same as or wider than a width of the partition wall 311. In the present embodiment, the width of the groove portion 371 is wider than the width of the partition wall 311. Such a groove portion 371 is formed to have a rectangular shape in plan view from the −Z side. Of course, the shape of the groove portion 371 in plan view from the −Z side is not limited to the rectangular shape, and may be a polygonal shape of pentagon or more, a circular shape, an elliptical shape, or the like.

With the provision of the groove portion 371 in the piezoelectric body 370, the rigidity of a portion of the vibration plate 350 facing an end portion of the pressure chamber 312 in the direction along the Y axis, that is, a so-called arm portion of the vibration plate 350 is suppressed, and thus the piezoelectric element 60 can be favorably displaced.

An example of such a piezoelectric body 370 includes a perovskite-structured crystal film made of a ferroelectric ceramic material indicating an electromechanical conversion action, which is formed on the electrode 360, a so-called perovskite-type crystal. As a material of such a piezoelectric body 370, for example, a ferroelectric piezoelectric material, such as lead zirconate titanate (PZT), or a material obtained by adding a metal oxide, such as niobium oxide, nickel oxide, or magnesium oxide, to the ferroelectric piezoelectric material, and specifically, lead titanate (PbTiO₃), lead zirconate titanate (Pb(Zr,Ti)O₃), lead zirconate (PbZrO₃), lead lanthanum titanate ((Pb,La),TiO₃), lead lanthanum zirconate titanate ((Pb,La)(Zr, Ti)O₃), or lead magnesium niobate zirconate titanate (Pb(Zr,Ti)(Mg,Nb)O₃), and the like may be used. The description will be made on the assumption that the piezoelectric body 370 of the present embodiment is lead zirconate titanate (PZT).

Further, the material of the piezoelectric body 370 is not limited to the lead-based piezoelectric material containing lead, and a lead-free piezoelectric material containing no lead may also be used. Examples of the lead-free piezoelectric material include bismuth ferrate ((BiFeO₃), abbreviated to “BFO”), barium titanate ((BaTiO₃), abbreviated to “BT”), potassium sodium niobate ((K,Na)(NbO₃), abbreviated to “KNN”), potassium sodium lithium niobate ((K,Na,Li)(NbO₃)), potassium sodium lithium tantalate niobate ((K,Na,Li)(Nb,Ta)O₃), bismuth potassium titanate ((Bi_{1/2}K_{1/2})TiO₃, abbreviated to “BKT”), bismuth sodium titanate ((Bi_{1/2}Na_{1/2})TiO₃, abbreviated to “BNT”), bismuth manganate (BiMnO₃, abbreviated to “BM”), a composite oxide containing bismuth, potassium, titanium, and iron and having a perovskite structure (x[(BiₓK₁₋ₓ)TiO₃]-(1−x)[BiFeO₃], abbreviated to “BKT-BF”), a composite oxide containing bismuth, iron, barium, and titanium and having a perovskite structure ((1−x)[BiFeO₃]-x[BaTiO₃], abbreviated to “BFO-BT”), and a material obtained by adding a metal such as manganese, cobalt, or chromium to the composite oxide ((1−x)[Bi(Fe_{1-y}M_{y})O₃]-x[BaTiO₃], (M being Mn, Co, or Cr)).

As shown in FIGS. 3, 5, and 6, the electrode 380 is located on a side of the piezoelectric body 370 opposite to the electrode 360 and on the −Z side of the piezoelectric body 370, and configures the common electrode common to a plurality of active portions 410. That is, the electrode 380 is provided in common to the plurality of pressure chambers 312. The electrode 380 is continuously provided over the direction along the Y axis with a length in the direction along the X axis as a predetermined length. The electrode 380 is also provided on inner surfaces of the groove portion 371, that is, on a side surface of the groove portion 371 of the piezoelectric body 370 and on the insulator film 352, which is the bottom surface of the groove portion 371. Regarding the inside of the groove portion 371, the electrode 380 may be provided only on a part of the inner surfaces of the groove portion 371, or does not need to be provided over the entire surface of the inner surfaces of the groove portion 371.

For example, as shown in FIG. 5, in the first pressure chamber column, an end portion 380a of the electrode 380 on the +X side is disposed on the +X side to be the outer side of the end portion 360a of the electrode 360 covered with the piezoelectric body 370. That is, the end portion 380a of the electrode 380 is located on the +X side that is an outer side of the end portion 312a of the pressure chamber 312 and is the outer side of the end portion 360a of the electrode 360. In the present embodiment, the end portion 380a of the electrode 380 substantially matches the end portion 370a of the piezoelectric body 370 in the direction along the X axis. Thus, an end portion of the active portion 410 on the +X side, that is, a boundary between the active portion 410 and the non-active portion 415 is prescribed by the end portion 360a of the electrode 360.

On the other hand, the end portion 380b of the electrode 380 on the −X side is located on the −X side that is an outer side of the end portion 312b of the pressure chamber 312 and on the +X side that is an inner side of the end portion 370b of the piezoelectric body 370. As described above, the end portion 370b of the piezoelectric body 370 is located on the inner side that is the +X side of the end portion 360b of the electrode 360. Therefore, the end portion 380b of the electrode 380 is located on the piezoelectric body 370 that is the +X side of the end portion 360b of the electrode 360. Thus, there is a portion where a surface of the piezoelectric body 370 is exposed on the end portion 380b of the electrode 380 on the −X side. As described above, the end portion 380b of the electrode 380 is disposed on the +X side of the end portion 370b of the piezoelectric body 370 and the end portion 360b of the electrode 360. Thus, an end portion of the active portion 410 on the −X side, that is, a boundary between the active portion 410 and the non-active portion 415 is prescribed by the end portion 380b of the electrode 380.

A material of such an electrode 380 is not particularly limited. For example, similarly to the electrode 360, a conductive material such as a metal such as platinum (Pt), iridium (Ir), gold (Au), and titanium (Ti), or a conductive metal oxide such as indium tin oxide abbreviated as ITO may be used, or a material in which a plurality of materials such as platinum (Pt), iridium (Ir), gold (Au), and titanium (Ti) are laminated may be used. The description will be made on the assumption that the electrode 380 of the present embodiment is iridium (Ir).

Further, on an outer side of the end portion 380b of the electrode 380, that is, further on the −X side of the end portion 380b of the electrode 380, a wiring portion 385 that is formed at the same layer as the electrode 380 but is electrically decoupled from the electrode 380 is provided. Further, the wiring portion 385 is formed over from on the piezoelectric body 370 to on the electrode 360 extending to the −X side of the piezoelectric body 370 in a state of being spaced not to be in contact with the end portion 380b of the electrode 380. The wiring portion 385 is provided independently for each active portion 410. That is, a plurality of wiring portions 385 are disposed at predetermined spacings in the direction along the Y axis. The wiring portion 385 may be formed in a layer separated from that of the electrode 380, but is preferably formed in the same layer as the electrode 380. Accordingly, steps of manufacturing the wiring portion 385 can be simplified, and thus costs can be reduced.

Further, an individual lead electrode 391 is coupled to the electrode 360 configuring the piezoelectric element 60, and a common lead electrode 392 that is a common electrode for driving is electrically coupled to the electrode 380. The wiring substrate 420 is electrically coupled to end portions of the individual lead electrode 391 and the common lead electrode 392 on a side opposite to end portions of the individual lead electrode 391 and the common lead electrode 392, which are coupled to the piezoelectric element 60. The control unit 10, a temperature information output circuit 26, and a plurality of wirings for coupling to a plurality of circuits (not illustrated) are formed in the wiring substrate 420. Such a wiring substrate 420 is made of, for example, a flexible printed circuit (FPC).

In the present embodiment, the individual lead electrode 391 and the common lead electrode 392 extend to be exposed in the through-hole 332 formed in the protective substrate 330, and are electrically coupled to the wiring substrate 420 in the through-hole 332. Further, the integrated circuit 421 that outputs a signal for driving the piezoelectric element 60 is mounted on the wiring substrate 420.

In the present embodiment, the individual lead electrode 391 and the common lead electrode 392 are formed at the same layer, but are formed to be electrically decoupled from each other. Accordingly, manufacturing steps can be simplified and thus costs can be reduced, compared with when the individual lead electrode 391 and the common lead electrode 392 are separately formed. Of course, the individual lead electrode 391 and the common lead electrode 392 may be formed at different layers.

A material of the individual lead electrode 391 and the common lead electrode 392 is not particularly limited as long as the material is conductive. For example, gold (Au), copper (Cu), titanium (Ti), tungsten (W), nickel (Ni), chromium (Cr), platinum (Pt), and aluminum (Al) may be used. The description will be made on the assumption that the individual lead electrode 391 and the common lead electrode 392 of the present embodiment are made of gold (Au). The individual lead electrode 391 and the common lead electrode 392 may have an adhesive layer for improving adhesiveness to the electrode 360 and the electrode 380 or the vibration plate 350.

The individual lead electrode 391 is provided for each active portion 410, that is, for each electrode 360. As shown in FIG. 5, for example, in the first pressure chamber column, the individual lead electrode 391 is coupled to the vicinity of the end portion 360b of the electrode 360, which is provided on the outer side of the piezoelectric body 370, via the wiring portion 385, and is drawn out in the direction along the −X side on the pressure chamber substrate 310 and actually to on the vibration plate 350.

On the other hand, as shown in FIG. 3, in the first pressure chamber column, the common lead electrode 392 is drawn out to the −X side from the electrode 380 configuring the common electrode on the piezoelectric body 370 to on the vibration plate 350, at both end portions in the direction along the Y axis. Further, the common lead electrode 392 has an extension portion 392a and an extension portion 392b. As shown in FIGS. 3 and 5, for example, in the first pressure chamber column, the extension portion 392a extends in the direction along the Y axis in a region corresponding to the end portion 312a of the pressure chamber 312, and the extension portion 392b extends in the direction along the Y axis to a region corresponding to the end portion 312b of the pressure chamber 312. The extension portion 392a and the extension portion 392b are continuously provided on the plurality of active portions 410 over the direction along the Y axis.

Further, the extension portion 392a and the extension portion 392b extend from the inner side of the pressure chamber 312 to the outer side of the pressure chamber 312, in the direction along the X axis. In the present embodiment, the active portion 410 of the piezoelectric element 60 extends to the outer side of the pressure chamber 312 at both end portions of the pressure chamber 312 in the direction along the X axis, and the extension portion 392a and the extension portion 392b extend to the outer side of the pressure chamber 312 on the active portion 410.

As shown in FIG. 5, the resistance wiring 401 is provided on a surface of the vibration plate 350 on the −Z side. The resistance wiring 401 detects a temperature of the pressure chamber 312 by using characteristics that an electrical resistance value changes according to the temperature. As a material of the resistance wiring 401, a material whose electrical resistance value is temperature dependent, for example, gold (Au), platinum (Pt), iridium (Ir), aluminum (Al), copper (Cu), titanium (Ti), tungsten (W), nickel (Ni), and chromium (Cr) may be used.

Among the above materials, platinum (Pt) has a large change in resistance value due to temperature, and has high stability and accuracy. Furthermore, platinum (Pt) also has high linearity of a change in resistance value to a temperature change. From this viewpoint, platinum (Pt) is preferably employed as the material of the resistance wiring 401. That is, the resistance wiring 401 is preferably configured by including platinum (Pt). Further, in the present embodiment, the resistance wiring 401 is laminated and formed at the surface of the vibration plate 350 on the −Z side to be in the same layer as the electrode 360 and electrically decoupled to the electrode 360. That is, the resistance wiring 401 includes a wiring pattern laminated on the surface of the vibration plate 350 on the −Z side in the direction along the Z axis, and the wiring pattern includes platinum (Pt).

As shown in FIG. 3, one end of the resistance wiring 401 is coupled to a lead electrode for measurement 393a, and the other end of the resistance wiring 401 is coupled to a lead electrode for measurement 393b. Further, the lead electrodes for measurement 393a and 393b are electrically coupled to the wiring substrate 420. Accordingly, a signal having a voltage value according to the electrical resistance value that changes with the temperature of the pressure chamber 312, which is the temperature of the pressure chamber 312 detected by the resistance wiring 401, is output from the print head 22.

Further, in the present embodiment, the resistance wiring 401 is covered with the piezoelectric body 370, and is located between the vibration plate 350 and the piezoelectric body 370 in the direction along the Z axis. The resistance wiring 401 includes a first pressure chamber column-side meandering pattern located on the +X side in the direction along the X axis, and a second pressure chamber column-side meandering pattern located on the −X side in the direction along the X axis. The first pressure chamber column-side meandering pattern is located, when viewed from −Z side, to be overlapped with the supply communication path 319 that communicates with each pressure chamber 312 configuring the first pressure chamber column, and meanders in the direction along the Y axis. The second pressure chamber column-side meandering pattern is located, when viewed from −Z side, to be overlapped with the supply communication path 319 that communicates with each pressure chamber 312 configuring the second pressure chamber column, and meanders in the direction along the Y axis. That is, the resistance wiring 401 includes the first pressure chamber column-side meandering pattern corresponding to the first pressure chamber column formed by the plurality of pressure chambers 312, and the second pressure chamber column-side meandering pattern corresponding to the second pressure chamber column formed by the plurality of pressure chambers 312.

Further, as shown in FIGS. 4 and 5, a distance between the end portion of the pressure chamber 312 on the −Z side and the resistance wiring 401 in the direction along the Z axis is smaller than a dimension of the pressure chamber 312 in the direction along the Z axis. Further, for example, in the first pressure chamber column, the longest distance between the end portion 312a of the pressure chamber 312 on the +X side and the resistance wiring 401 in the direction along the X axis is smaller than a dimension of the pressure chamber 312 in the direction along the X axis. Thus, the electrical resistance value of the resistance wiring 401 is likely to change according to the change in the temperature of the pressure chamber 312. In the present embodiment, the lead electrode for measurement 393 including the lead electrode for measurement 393a and the lead electrode for measurement 393b is formed at the same layer as the individual lead electrode 391 and the common lead electrode 392, but is electrically decoupled. Accordingly, manufacturing steps can be simplified and thus costs can be reduced, compared with when the lead electrode for measurement 393 is formed separately from the individual lead electrode 391 and the common lead electrode 392. Of course, the lead electrode for measurement 393 may be formed at a layer different from the individual lead electrode 391 and the common lead electrode 392.

A material of the lead electrode for measurement 393 is not particularly limited as long as the material is conductive. For example, gold (Au), copper (Cu), titanium (Ti), tungsten (W), nickel (Ni), chromium (Cr), platinum (Pt), and aluminum (Al) may be used. The description will be made on the assumption that the lead electrode for measurement 393 of the present embodiment is gold (Au). That is, the material of the lead electrode for measurement 393 in the present embodiment is the same as that of the individual lead electrode 391 and the common lead electrode 392. Further, the lead electrode for measurement 393 may have an adhesive layer that improves adhesiveness to the resistance wiring 401 and the vibration plate 350.

As described above, in the present embodiment, the lead electrode for measurement 393 extends to be exposed in the through-hole 332 formed in the protective substrate 330, and is electrically coupled to the wiring substrate 420 in the through-hole 332. Accordingly, the electrical resistance value of the resistance wiring 401, which is changed according to the temperature of the pressure chamber 312, is output from the print head 22 via the wiring substrate 420.

That is, the print head 22 included in the head unit 20 in the present embodiment includes: the piezoelectric element 60 that includes the electrode 360, the electrode 380, and the piezoelectric body 370, has the piezoelectric body 370 that is located between the electrode 360 and the electrode 380 in the direction along the Z axis in which the electrode 360, the electrode 380, and the piezoelectric body 370 are laminated, and receives the drive signal COM to be driven; the vibration plate 350 that is located on the +Z side, which is one side of the piezoelectric element 60 in the direction along the Z axis, and is deformed by the drive of the piezoelectric element 60; the pressure chamber substrate 310 that is located on the +Z side, which is one side of the vibration plate 350 in the direction along the Z axis, and provided with the pressure chamber 312 in which the ink is stored and whose volume is changed due to the deformation of the vibration plate 350; the nozzle 321 that ejects the ink according to the change in the volume of the pressure chamber 312; and the resistance wiring 401 that is located on the −Z side, which is the other side of the vibration plate 350 in the direction along the Z axis, and acquires the temperature of the pressure chamber 312 according to the temperature.

### 3. Configuration of Liquid Ejecting Apparatus

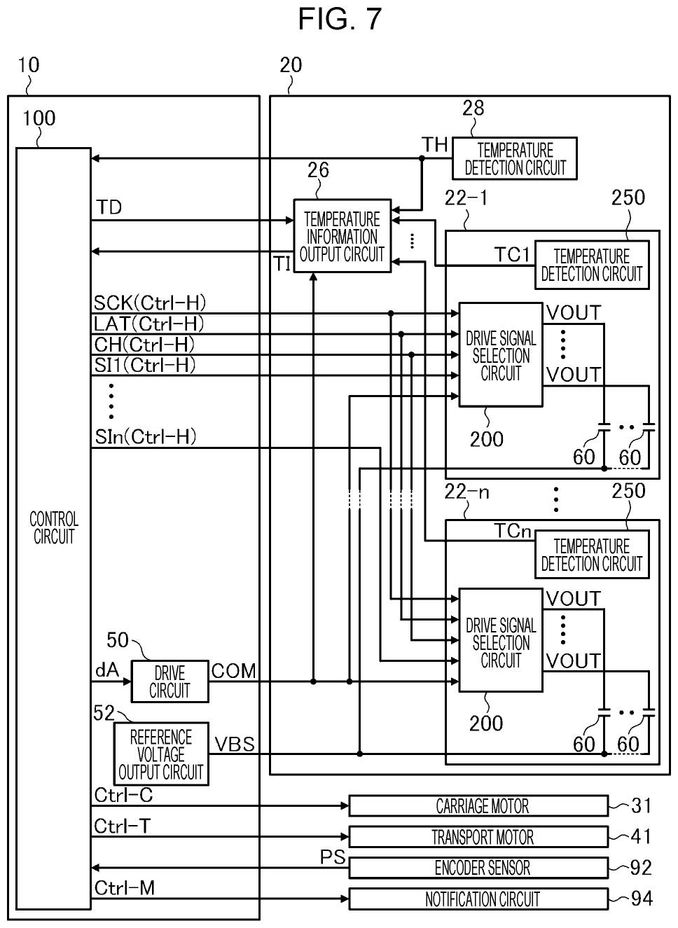

Next, a functional configuration of the liquid ejecting apparatus 1 will be described. FIG. 7 is a diagram showing the functional configuration of the liquid ejecting apparatus 1. As shown in FIG. 7, the liquid ejecting apparatus 1 includes the control unit 10, the head unit 20, the carriage motor 31, the transport motor 41, an encoder sensor 92, and a notification circuit 94.

The control unit 10 includes a drive circuit 50, a reference voltage output circuit 52, and a control circuit 100. The control circuit 100 includes, for example, a processing circuit, such as a CPU or an FPGA, and a storage circuit, such as a semiconductor memory. The control circuit 100 receives an image information signal including image data or the like from an external device such as a host computer that is coupled to the outside of the liquid ejecting apparatus 1 in a communicable manner. The control circuit 100 generates various signals for controlling the liquid ejecting apparatus 1 based on the input image information signal, and outputs the generated various signals to corresponding configurations.

In a specific example, the control circuit 100 receives, from the encoder sensor 92, a position detection signal PS based on a scanning position of the above carriage 21 included in the head unit 20, in addition to the above image information signal. The control circuit 100 perceives, based on the input position detection signal PS, a scanning position of the head unit 20 including the print head 22 equipped on the carriage 21, which is the scanning position of the carriage 21. The control circuit 100 generates various signals according to the input image information signal and the perceived scanning position of the head unit 20, and outputs the generated various signals to corresponding configurations.

Specifically, the control circuit 100 generates the control signal Ctrl-C for controlling movement of the head unit 20 along the scanning axis according to the scanning position of the head unit 20, and outputs the generated control signal Ctrl-C to the carriage motor 31. Accordingly, the carriage motor 31 is operated to control the movement of the head unit 20 equipped on the carriage 21 along the scanning axis and the scanning position thereof. Further, the control circuit 100 generates the control signal Ctrl-T for controlling the transport of the medium P, and outputs the generated control signal Ctrl-T to the transport motor 41. Accordingly, the transport motor 41 is operated to control movement of the medium P along the transport direction. The control signal Ctrl-C may be subjected to signal conversion via a driver circuit (not illustrated) and then input to the carriage motor 31, and the control signal Ctrl-T may be subjected to signal conversion via a driver circuit (not illustrated) and then input to the transport motor 41.

Further, the control circuit 100 generates print data signals SI1 to SIn, a change signal CH, a latch signal LAT, and a clock signal SCK, as the control signal Ctrl-H for controlling the head unit 20, based on the image information signal input from the external device and the scanning position of the head unit 20, and outputs the generated signals to the head unit 20.

Furthermore, the control circuit 100 generates a temperature acquisition request signal TD for acquiring information on the temperature of the head unit 20, and outputs the generated temperature acquisition request signal TD to the head unit 20. Accordingly, the control circuit 100 receives a temperature information signal TI including the information on the temperature of the head unit 20 in response to the temperature acquisition request signal TD. The control circuit 100 perceives the temperature of the head unit 20 based on the input temperature information signal TI, corrects the control signals Ctrl-H, Ctrl-C, and Ctrl-T based on the perceived temperature, and outputs the corrected control signals to corresponding configurations. Accordingly, the operations of the liquid ejecting apparatus 1 and the head unit 20 are controlled in response to the temperature information signal TI, which is the temperature of the print head 22. As a result, ejection accuracy of the ink ejected from the liquid ejecting apparatus 1 and the head unit 20 is improved.

Further, the control circuit 100 generates a base drive signal dA, which is a digital signal as the control signal Ctrl-H, and outputs the generated base drive signal dA to the drive circuit 50. The drive circuit 50 generates the drive signal COM having a signal waveform prescribed by the base drive signal dA as the drive signal COM, and outputs the generated drive signal COM to the head unit 20.

Specifically, the base drive signal dA output by the control circuit 100 is input to the drive circuit 50. The drive circuit 50 performs digital/analog signal conversion on the input base drive signal dA and then performs class D amplification on the converted analog signal to generate the drive signal COM and output the generated drive signal COM to the head unit 20. That is, the control circuit 100 outputs the base drive signal dA as the control signal Ctrl-H corrected based on the temperature information signal TI, and the drive circuit 50 outputs the drive signal COM having the corrected signal waveform in accordance with the base drive signal dA corrected based on the temperature information signal TI. Here, the description will be made on the assumption that the base drive signal dA output by the control circuit 100 is the digital signal that prescribes the signal waveform of the drive signal COM, but the base drive signal dA may be an analog signal as long as the signal prescribes the signal waveform of the drive signal COM. Further, the drive circuit 50 may perform class A amplification, class B amplification, and class AB amplification on the signal waveform prescribed by the base drive signal dA to generate the drive signal COM.

As described above, the drive circuit 50 generates and outputs the drive signal COM based on the base drive signal dA. In this case, the base drive signal dA output by the control circuit 100, which is input to the drive circuit 50, is also corrected based on the temperature of the head unit 20 perceived based on the temperature information signal TI. Therefore, the drive circuit 50 outputs the drive signal COM corrected based on the temperature of the head unit 20.

The reference voltage output circuit 52 generates a reference voltage signal VBS and outputs the generated reference voltage signal VBS to the head unit 20. The reference voltage signal VBS is a signal having a constant voltage value as a reference for driving the piezoelectric element 60, and is supplied to the electrode 380, which is the common electrode. The voltage value of such a reference voltage signal VBS may be, for example, at a ground potential, which is a constant signal, or may be at a potential of 5.5 V, 6 V, or the like, which is a constant signal.

Further, the control circuit 100 generates a control signal Ctrl-M for notifying a user of operation situations of the drive circuit 50, the reference voltage output circuit 52, and the head unit 20, and outputs the generated control signal Ctrl-M to the notification circuit 94. The notification circuit 94 notifies the user of information according to the control signal Ctrl-M. Accordingly, the user is notified of the operation situation of the liquid ejecting apparatus 1. Such a notification circuit 94 may be a display that makes notification of the information by characters or images, or may be a speaker that makes notification of the information by sound.

The head unit 20 has print heads 22-1 to 22-n as the plurality of print heads 22, the temperature information output circuit 26, and a temperature detection circuit 28. Further, each of the print heads 22-1 to 22-n includes a drive signal selection circuit 200, a temperature detection circuit 250, and a plurality of piezoelectric elements 60.

The print head 22-1 receives the print data signal SI1, the change signal CH, the latch signal LAT, the clock signal SCK, the drive signal COM, and the reference voltage signal VBS, which are output by the control circuit 100. The clock signal SCK, the latch signal LAT, the change signal CH, the print data signal SI1, and the drive signal COM, which are input to the print head 22-1, are input to the drive signal selection circuit 200.

The drive signal selection circuit 200 selects or does not select the signal waveform included in the drive signal COM, based on the input clock signal SCK, latch signal LAT, change signal CH, and print data signal SI1, to generate a drive signal VOUT corresponding to each of the plurality of piezoelectric elements 60. The drive signal selection circuit 200 outputs the generated drive signal VOUT to each electrode 360 that is one end of each corresponding piezoelectric element 60 and is the individual electrode. In this case, the reference voltage signal VBS is commonly input to the electrode 380 that is the other ends of the plurality of piezoelectric elements 60 and is the common electrode. Accordingly, each of the plurality of piezoelectric elements 60 is displaced by a potential difference between the drive signal VOUT input to the electrode 360 and the reference voltage signal VBS input to the electrode 380. As a result, the ink of an amount corresponding to the displacement of the piezoelectric element 60 is ejected from the corresponding nozzle 321 included in the print head 22-1.

That is, the print head 22-1 receives the drive signal COM and ejects the ink. At least a part of the drive signal selection circuit 200 may be mounted on the wiring substrate 420 of the print head 22-1, as the integrated circuit 421 described above.

Further, the temperature detection circuit 250 included in the print head 22-1 detects a temperature of the print head 22-1. The temperature detection circuit 250 outputs, to the temperature information output circuit 26, a head temperature signal TC1 corresponding to the detected temperature of the print head 22-1. A part of the temperature detection circuit 250 may be provided in the print head 22-1, and a different part thereof may be provided outside the print head 22-1. In this case, the part of the temperature detection circuit 250 provided in the print head 22-1 corresponds to the resistance wiring 401 described above. That is, a voltage value of the head temperature signal TC1 corresponding to the temperature of the print head 22-1 output by the temperature detection circuit 250 changes according to a resistance value of the resistance wiring 401 that changes with the temperature. In other words, the voltage value of the head temperature signal TC1 output by the temperature detection circuit 250 is the temperature of the print head 22-1, and changes according to the temperature of the pressure chamber 312 included in the print head 22-1.

The print heads 22-2 to 22-n have the same configuration as the print head 22-1 except that the input and output signals are different, and execute the same operation. Specifically, the clock signal SCK, the latch signal LAT, the change signal CH, the print data signal SIi, the drive signal COM, and the reference voltage signal VBS are input to the print head 22-i, i being any of 2 to n. The drive signal selection circuit 200 included in the print head 22-i selects or does not select the signal waveform of the drive signal COM, based on the input clock signal SCK, latch signal LAT, change signal CH, and print data signal SIi, to generate the drive signal VOUT corresponding to each of the plurality of the piezoelectric element 60 and output the generated drive signal VOUT to the electrode 360 of the corresponding piezoelectric element 60. Further, the reference voltage signal VBS is commonly input to the electrode 380 of the plurality of piezoelectric elements 60 included in the print head 22-i. Accordingly, the plurality of piezoelectric elements 60 of the print head 22-i are driven to eject, from the nozzle 321 included in the print head 22-i, the ink of an amount corresponding to the drive of the piezoelectric elements 60. That is, the print heads 22-2 to 22-n also receive the drive signal COM and eject the ink.

Further, the temperature detection circuit 250 included in the print head 22-i outputs, to the temperature information output circuit 26, a head temperature signal TCi having a voltage value corresponding to a temperature of the print head 22-i. In this case, at least a part of the drive signal selection circuit 200 included in the print head 22-i is mounted on the wiring substrate 420 of the print head 22-i as the integrated circuit 421 described above, and at least a part of the temperature detection circuit 250 included in the print head 22-i is provided on the print head 22-i as the resistance wiring 401 described above.

The following description will be made on the assumption that the clock signal SCK, the latch signal LAT, the change signal CH, and the print data signals SI as the print data signals SI1 to SIn, the drive signal COM, and the reference voltage signal VBS are input to the print head 22 when there is no need to distinguish the print heads 22-1 to 22-n. Further, the description will be made on the assumption that the temperature detection circuit 250 of the print head 22 outputs the head temperature signal TC as the head temperature signals TC1 to TCn having voltage values corresponding to the temperature of the print head 22.

The temperature detection circuit 28 detects the temperature of the head unit 20 including the print heads 22-1 to 22-n. The temperature detection circuit 28 generates a unit temperature signal TH having a voltage value corresponding to the detected temperature. The temperature detection circuit 28 outputs the generated unit temperature signal TH to the temperature information output circuit 26 and the control circuit 100. Such a temperature detection circuit 28 is configured by including a thermistor element or the like whose resistance value changes according to the change in the temperature of the head unit 20.

The temperature information output circuit 26 generates the temperature information signal TI in accordance with the head temperature signals TC1 to TCn output by respective print heads 22-1 to 22-n, the unit temperature signal TH output by the temperature detection circuit 28, the temperature acquisition request signal TD output by the control circuit 100, and the drive signal COM output by the drive circuit 50, and outputs the generated temperature information signal TI to the control circuit 100.

Specifically, the temperature information output circuit 26 selects the head temperature signal TC from the head temperature signals TC1 to TCn in response to the temperature acquisition request signal TD input from the control circuit 100, and acquires a digital signal corresponding to the selected head temperature signal TC at a timing corresponding to the voltage value of the drive signal COM output by the drive circuit 50. The acquired digital signal is corrected based on the unit temperature signal TH, and the temperature information signal TI corresponding to the corrected signal is output to the control circuit 100. That is, the temperature information output circuit 26 acquires the head temperature signals TC1 to TCn corresponding to the temperatures of the print heads 22-1 to 22-n. The temperature information signal TI corresponding to the acquired head temperature signals TC1 to TCn is generated, and the generated temperature information signal TI is output to the control circuit 100. Details of a configuration and operation of such a temperature information output circuit 26 will be described below.

### 4. Signal Waveform of Drive Signal COM and Configuration of Drive Signal Selection Circuit

Next, a configuration and operation of the drive signal selection circuit 200 included in the print head 22 will be described. As described above, the drive signal selection circuit 200 included in the print head 22 selects or does not select the signal waveform of the drive signal COM, based on the clock signal SCK, the print data signal SI, the latch signal LAT, and the change signal CH, to generate the drive signal VOUT, and output the generated drive signal VOUT to the corresponding piezoelectric element 60. In describing the configuration and operation of the drive signal selection circuit 200, first, an example of the waveform of the drive signal COM input to the drive signal selection circuit 200 in a period during which the ink is ejected to the medium P will be described. In the following description, the period during which the ink is ejected to the medium P may be referred to as an ejection period.

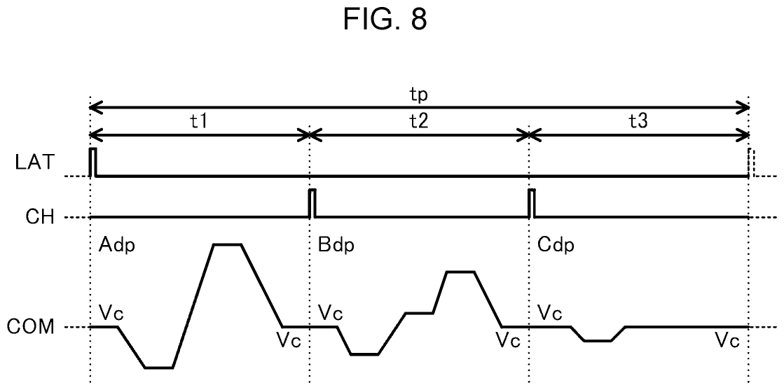

FIG. 8 is a diagram showing an example of the signal waveform of the drive signal COM in the ejection period. As shown in FIG. 8, in the ejection period, the drive signal COM includes a trapezoidal waveform Adp disposed within a period t1 from rise of the latch signal LAT to rise of the change signal CH, a trapezoidal waveform Bdp disposed within a period t2 from rise of the change signal CH to rise of the next change signal CH, and a trapezoidal waveform Cdp disposed within a period t3 from rise of the change signal CH to rise of the latch signal LAT. The trapezoidal waveform Adp is a signal waveform for driving the piezoelectric element 60 to eject the ink having a predetermined amount, the trapezoidal waveform Bdp is a signal waveform for driving the piezoelectric element 60 to eject the ink having an amount smaller than the predetermined amount, and the trapezoidal waveform Cdp is a signal waveform for driving the piezoelectric element 60 to such an extent that the ink is not ejected. When the trapezoidal waveform Cdp is supplied to the corresponding piezoelectric element 60, the trapezoidal waveform Cdp is a signal waveform for causing the ink near a corresponding nozzle opening portion to vibrate to reduce a risk that ink viscosity is increased in the vicinity of the nozzle opening portion.

Further, the trapezoidal waveforms Adp, Bdp, and Cdp are signal waveforms having voltage values of a common voltage Vc at respective start and end timings. In other words, each of the trapezoidal waveforms Adp, Bdp, and Cdp is started at the voltage Vc and is ended at the voltage Vc.

In the following description, when the trapezoidal waveform Adp is supplied to the piezoelectric element 60, an ejected amount of the ink having the predetermined amount may be referred to as a medium amount, and when the trapezoidal waveform Bdp is supplied to the piezoelectric element 60, an ejected amount of the ink that is smaller than the predetermined amount may be referred to as a small amount. Further, when the trapezoidal waveform Cdp is supplied to the piezoelectric element 60, the operation of causing the ink near the nozzle opening portion corresponding to the piezoelectric element 60 to vibrate to prevent the ink viscosity from increasing may be referred to as micro-vibration. The signal waveform of the drive signal COM shown in FIG. 8 is an example, and the present disclosure is not limited thereto. Various combinations of waveforms may be used according to properties of the ink to be ejected, a material of the medium P on which the ink is landed, and the like.

The drive signal selection circuit 200 selects or does not select the trapezoidal waveforms Adp, Bdp, and Cdp included in the drive signal COM in a cycle tp including the periods t1, t2, and t3. Accordingly, the drive signal selection circuit 200 controls the ejection amount of the ink ejected from each of the plurality of nozzles 321 in the cycle tp. That is, the drive signal selection circuit 200 controls a dot size formed at the medium P in the cycle tp. In the cycle tp including the periods t1, t2, and t3, dots having a predetermined size are formed at the medium P. The cycle tp in which the dots having the predetermined size are formed corresponds to a dot formation cycle.

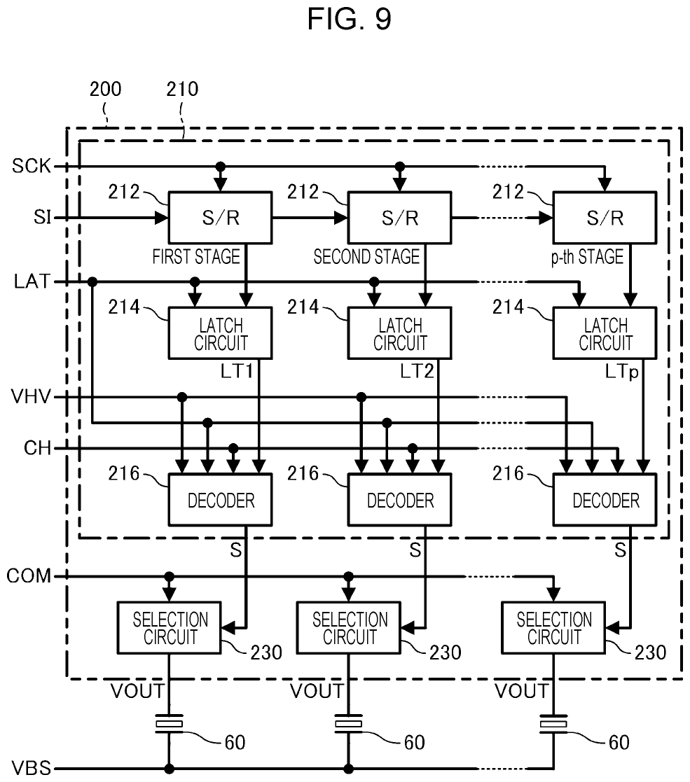

Next, the configuration and operation of the drive signal selection circuit 200 that selects or does not select the signal waveform included in the drive signal COM to generate the drive signal VOUT will be described. FIG. 9 is a diagram showing the configuration of the drive signal selection circuit 200. As shown in FIG. 9, the drive signal selection circuit 200 has a selection control circuit 210 and a plurality of selection circuits 230 having the same number as the plurality of piezoelectric elements 60. The following description will be made on the assumption that the print head 22 has p piezoelectric elements 60. That is, the drive signal selection circuit 200 has p selection circuits 230.

The selection control circuit 210 receives the clock signal SCK, the print data signal SI, the latch signal LAT, and the change signal CH. Further, in the selection control circuit 210, a set of a shift register (S/R) 212, a latch circuit 214, and a decoder 216 is provided in correspondence with each of the p piezoelectric elements 60. That is, the drive signal selection circuit 200 includes p shift registers 212, p latch circuits 214, and p decoders 216.

The print data signal SI is input to the selection control circuit 210 in synchronization with the clock signal SCK. Further, the print data signal SI serially includes 2-bit print data[SIH, SIL] for selecting any one of “large dot LD”, “medium dot MD”, “small dot SD”, and “non-recording ND” in correspondence with each of the p piezoelectric elements 60. The print data[SIH, SIL] included in the print data signal SI is held in the p shift registers 212 corresponding to the p piezoelectric elements 60. Specifically, the p shift registers 212 corresponding to the piezoelectric element 60 are coupled in cascade to each other, and the serially input print data signal SI is sequentially transferred to the shift register 212 on a subsequent stage in accordance with the clock signal SCK. When the print data[SIH, SIL] is held in the corresponding shift register 212, the clock signal SCK is stopped. Accordingly, the print data[SIH, SIL] included in the print data signal SI is held in the corresponding shift registers 212. In FIG. 9, in order to distinguish the p shift registers 212 from each other, the shift registers 212 are denoted as a first stage, a second stage, . . . , p-th stage in order from upstream where the print data signal SI is input.

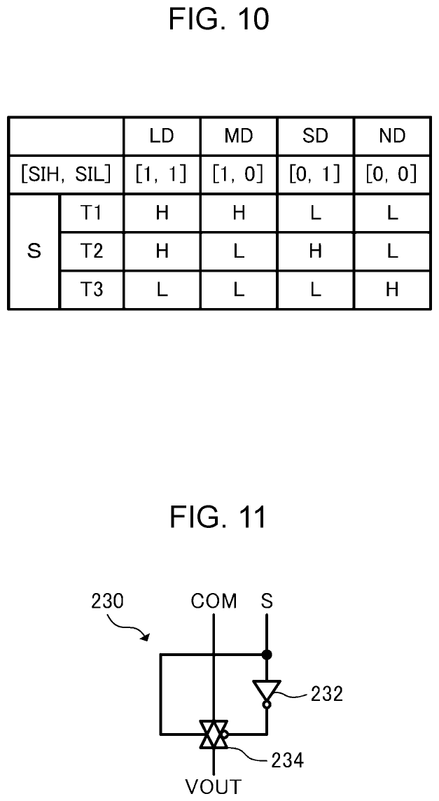

Respective p latch circuits 214 latch the print data[SIH, SIL] held in the corresponding shift registers 212 all at once at the rise of the latch signal LAT. The print data[SIH, SIL] latched by the latch circuit 214 is input to the corresponding decoder 216. FIG. 10 is a table showing an example of decoding contents in the decoder 216. The decoder 216 outputs a selection signal S having a logic level that is prescribed by the input print data[SIH, SIL] within each of the periods t1, t2, and t3. For example, when the print data[SIH, SIL]=[1, 0] is input to the decoder 216, the decoder 216 outputs the logic levels of the selection signal S as H, L, and L levels within the periods t1, t2, and t3.

The selection signal S output by the decoder 216 is input to the selection circuit 230. The selection circuit 230 is provided in correspondence with each of the p piezoelectric elements 60. In other words, the drive signal selection circuit 200 has the p selection circuits 230 having the same number as the p piezoelectric elements 60. FIG. 11 is a diagram showing a configuration of the selection circuit 230. As shown in FIG. 11, the selection circuit 230 includes an inverter 232, which is a NOT circuit, and a transfer gate 234.

The selection signal S is input to a positive control end not marked with a circle in the transfer gate 234, and is also input to a negative control end marked with the circle in the transfer gate 234 after the logic level of the selection signal S is inverted by the inverter 232. Further, the drive signal COM is supplied to an input end of the transfer gate 234. When the selection signal S of H level is input, the transfer gate 234 is conductive between the input end and an output end, and when the selection signal S of L level is input, the transfer gate 234 is non-conductive between the input end and the output end. That is, the transfer gate 234 outputs the signal waveform of the drive signal COM from the output end when the logic level of the selection signal S is the H level, and does not output the signal waveform of the drive signal COM from the output end when the logic level of the selection signal S is the L level. The drive signal selection circuit 200 outputs the signal output to the output end of the transfer gate 234 included in the selection circuit 230 as the drive signal VOUT.

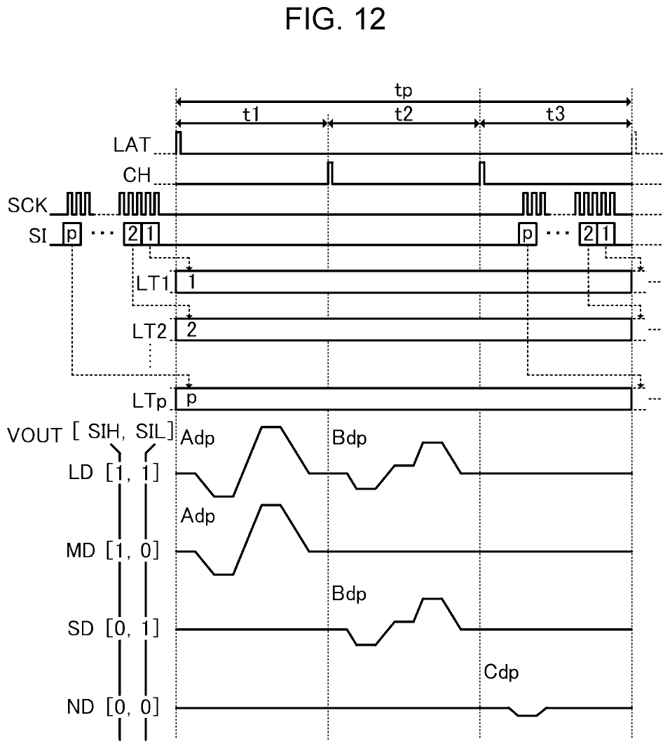

The operation of the drive signal selection circuit 200 will be described with reference to FIG. 12. FIG. 12 is a diagram for describing the operation of the drive signal selection circuit 200. The print data signal SI is input to the selection control circuit 210, as a serial signal synchronized with the clock signal SCK. The print data signals SI are sequentially transferred in the p shift registers 212 corresponding to the p piezoelectric elements 60, in synchronization with the clock signal SCK. Thereafter, when the input of the clock signal SCK is stopped, the print data[SIH, SIL] corresponding to each of the p piezoelectric elements 60 is held in the shift register 212. The print data signal SI is input in an order of the p-th stage, . . . , the second stage, and the first stage of the shift register 212, which corresponds to the piezoelectric element 60.

When the latch signal LAT rises, respective latch circuits 214 latch the print data[SIH, SIL] held in the shift registers 212 all at once. LT1, LT2, . . . , and LTp shown in FIG. 12 indicate the print data[SIH, SIL] latched by the latch circuits 214 corresponding to the first stage, second stage, . . . , and p-th stage shift registers 212.

The decoder 216 outputs the logic levels of the selection signal S in each of the periods t1, t2, and t3 with contents shown in FIG. 12, according to the size of the dot prescribed by the latched print data[SIH, SIL]. The selection circuit 230 selects or does not select the signal waveform of the drive signal COM, according to the logic level of the selection signal S output by the decoder 216, to generate the drive signal VOUT.

Specifically, when the print data[SIH, SIL]=[1, 1] is input to the decoder 216, the decoder 216 sets the logic level of the selection signal S to H, H, and L levels within the periods t1, t2, and t3. Accordingly, the selection circuit 230 selects the trapezoidal waveform Adp within the period t1, selects the trapezoidal waveform Bdp within the period t2, and does not select the trapezoidal waveform Cdp within the period t3. As a result, the drive signal selection circuit 200 outputs the drive signal VOUT corresponding to the “large dot LD”.

When the drive signal VOUT corresponding to the “large dot LD” is supplied to the piezoelectric element 60, the ink having the medium amount is ejected within the period t1, the ink having the small amount is ejected within the period t2, and the ink is not ejected within the period t3. The ejected ink having the medium amount and the ejected ink having the small amount land on the medium P and are combined to form the “large dot LD” on the medium P.

Further, when the print data[SIH, SIL]=[1, 0] is input to the decoder 216, the decoder 216 sets the logic level of the selection signal S to H, L, and L levels within the periods t1, t2, and t3. Accordingly, the selection circuit 230 selects the trapezoidal waveform Adp within the period t1, does not select the trapezoidal waveform Bdp within the period t2, and does not select the trapezoidal waveform Cdp within the period t3. As a result, the drive signal selection circuit 200 outputs the drive signal VOUT corresponding to the “medium dot MD”.

When the drive signal VOUT corresponding to the “medium dot MD” is supplied to the piezoelectric element 60, the ink having the medium amount is ejected within the period t1, the ink is not ejected within the period t2, and the ink is not ejected within the period t3. The ejected ink having the medium amount lands on the medium P, and thus the “medium dot MD” is formed at the medium P.

Further, when the print data[SIH, SIL]=[0, 1] is input to the decoder 216, the decoder 216 sets the logic level of the selection signal S to L, H, and L levels within the periods t1, t2, and t3. Accordingly, the selection circuit 230 does not select the trapezoidal waveform Adp within the period t1, selects the trapezoidal waveform Bdp within the period t2, and does not select the trapezoidal waveform Cdp within the period t3. As a result, the drive signal selection circuit 200 outputs the drive signal VOUT corresponding to the “small dot SD”.

When the drive signal VOUT corresponding to the “small dot SD” is supplied to the piezoelectric element 60, the ink is not ejected within the period t1, the ink having the small amount is ejected within the period t2, and the ink is not ejected within the period t3. The ejected ink having the small amount lands on the medium P, and thus the “small dot SD” is formed at the medium P.

Further, when the print data[SIH, SIL]=[0, 0] is input to the decoder 216, the decoder 216 sets the logic level of the selection signal S to L, L, and H levels within the periods t1, t2, and t3. Accordingly, the selection circuit 230 does not select the trapezoidal waveform Adp within the period t1, does not select the trapezoidal waveform Bdp within the period t2, and selects the trapezoidal waveform Cdp within the period t3. As a result, the drive signal selection circuit 200 outputs the drive signal VOUT corresponding to the “non-recording ND”.

When the drive signal VOUT corresponding to the “non-recording ND” is supplied to the piezoelectric element 60, the ink is not ejected within the period t1, the ink is not ejected within the period t2, and the ink is not ejected within the period t3. Therefore, the “non-recording ND” in which the dots are not formed at the medium P is obtained. In this case, the drive signal VOUT including the trapezoidal waveform Cdp is input to the corresponding piezoelectric element 60. Therefore, the micro-vibration is executed. As a result, the risk that the ink viscosity is increased in the vicinity of the opening portion of the corresponding nozzle 321 is reduced.

As described above, the drive signal selection circuit 200 selects or does not select the signal waveform of the drive signal COM, which is output by the drive circuit 50, to generate the drive signal VOUT and output the generated drive signal VOUT to the corresponding piezoelectric element 60. With the above, the print head 22 ejecting the ink based on the drive signal VOUT can also be considered to eject the ink based on the drive signal COM.

### 5. Configuration of Temperature Detection Circuit

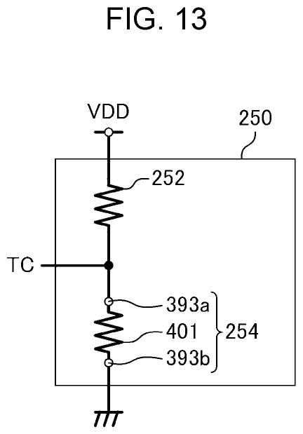

Next, a configuration of the temperature detection circuit 250 will be described. FIG. 13 is a diagram showing an example of the configuration of the temperature detection circuit 250. As shown in FIG. 13, the temperature detection circuit 250 has resistors 252 and 254. Further, the resistor 254 includes the resistance wiring 401 and the lead electrodes for measurement 393a and 393b, which are described above. That is, the print head 22 is provided with at least the resistor 254 in the temperature detection circuit 250. The print head 22 may be provided with the entire temperature detection circuit 250.

A voltage signal VDD having a constant voltage value is supplied to one end of the resistor 252. The other end of the resistor 252 is one end of the resistor 254, and is electrically coupled to the lead electrode for measurement 393a included in the resistor 254. The ground potential is supplied to the lead electrode for measurement 393b included in the resistor 254, which is the other end of the resistor 254. The temperature detection circuit 250 outputs, as the head temperature signal TC, a voltage value generated at a coupling point between the other end of the resistor 252 and one end of the resistor 254. That is, the temperature detection circuit 250 outputs, as the head temperature signal TC, a signal having a voltage value obtained by dividing the voltage signal VDD by a resistance value of the resistor 252 and the resistance value of the resistance wiring 401.

As described above, the resistance value of the resistance wiring 401 is the temperature of the print head 22 and changes according to the temperature of the pressure chamber 312. That is, the resistor 254 including the resistance wiring 401 functions as the thermistor element whose resistance value changes with temperature. With the change in the resistance value of the resistance wiring 401 according to the temperature of the pressure chamber 312, which is the temperature of the print head 22, the voltage value of the head temperature signal TC output by the temperature detection circuit 250 also changes according to the temperature of the pressure chamber 312, which is the temperature of the print head 22. That is, the temperature detection circuit 250 outputs the head temperature signal TC whose voltage value changes according to the temperature of the pressure chamber 312, which is the temperature of the print head 22.

In the temperature detection circuit 250 of the present embodiment, the description is made on the assumption that the resistor 254 on a low potential side is configured by including the resistance wiring 401 and the lead electrodes for measurement 393a and 393b, among the resistors 252 and 254 that divide the voltage signal VDD. However, the resistor 252 on a high potential side may be configured by including the resistance wiring 401 and the lead electrodes for measurement 393a and 393b. Further, the temperature detection circuit 250 may be configured by including a plurality of resistance elements, in addition to the resistors 252 and 254.

### 6. Configuration of Temperature Information Output Circuit

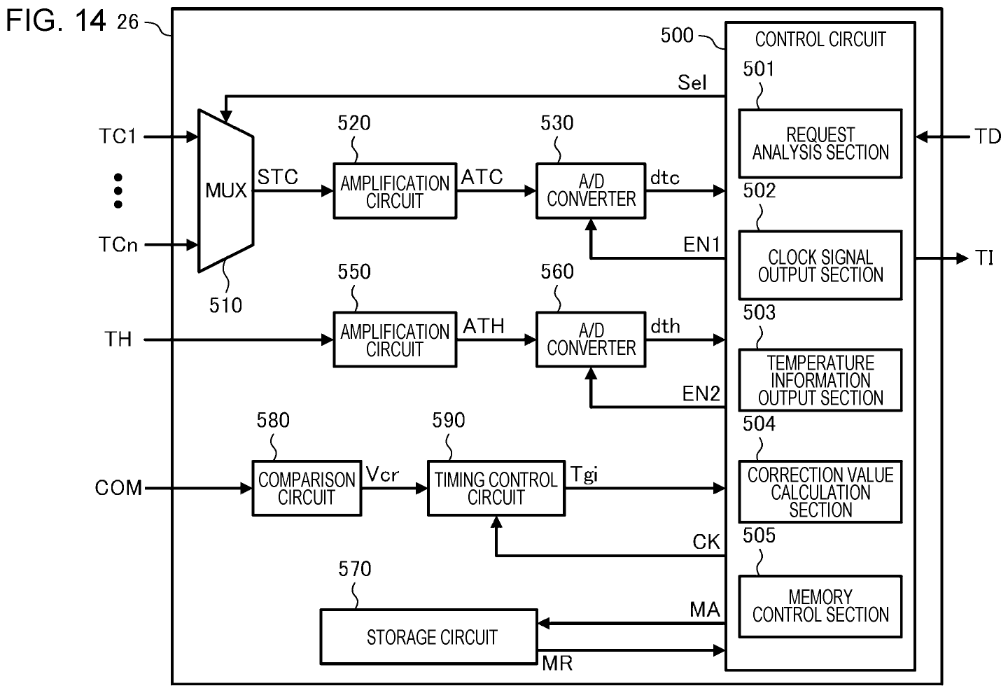

Next, a configuration and operation of the temperature information output circuit 26 will be described. FIG. 14 is a diagram showing an example of the configuration of the temperature information output circuit 26. The temperature information output circuit 26 selects at least any one of the head temperature signals TC1 to TCn input from respective print heads 22-1 to 22-n, based on the temperature acquisition request signal TD input from the control circuit 100, to acquire the selected head temperature signal TC at a timing prescribed by the drive signal COM. The temperature information output circuit 26 generates the temperature information signal TI corresponding to the temperature of the print head 22, based on the acquired head temperature signal TC and the unit temperature signal TH input from the temperature detection circuit 28, and outputs the generated temperature information signal TI to the control circuit 100.

As shown in FIG. 14, the temperature information output circuit 26 includes a control circuit 500, a multiplexer 510, amplification circuits 520 and 550, A/D converters 530 and 560, a storage circuit 570, a comparison circuit 580, and a timing control circuit 590.

The multiplexer 510 receives the head temperature signals TC1 to TCn output by respective print heads 22-1 to 22-n. Further, the multiplexer 510 also receives a select signal Sel output by the control circuit 500. The multiplexer 510 selects any one of the head temperature signals TC1 to TCn according to the input select signal Sel, and outputs the selected head temperature signal as a selection temperature signal STC.

The amplification circuit 520 receives the selection temperature signal STC output by the multiplexer 510. The amplification circuit 520 amplifies a voltage value of the input selection temperature signal STC to generate and output an amplified head temperature signal ATC.

The A/D converter 530 receives the amplified head temperature signal ATC output by the amplification circuit 520, and an enable signal EN1 output by the control circuit 500. The A/D converter 530 acquires a voltage value of the amplified head temperature signal ATC at a timing at which the enable signal EN1 for enabling the operation of the A/D converter 530 is input, generates a digital signal according to the acquired voltage value, and outputs the generated digital signal as digital temperature information dtc to the control circuit 500. That is, the A/D converter 530 generates the digital temperature information dtc corresponding to the temperature of the print head 22, which corresponds to the head temperature signal TC selected by the multiplexer 510, at the timing at which the enable signal EN1 for enabling the operation thereof is input, the digital temperature information dtc corresponding to the voltage value of the amplified head temperature signal ATC obtained by amplifying the head temperature signal TC selected by the multiplexer 510 with the amplification circuit 520, and outputs the generated digital temperature information dtc to the control circuit 500.

The following description will be made on the assumption that the A/D converter 530 is enabled to operate when the enable signal EN1 rises. That is, the description will be made on the assumption that the A/D converter 530 generates the digital temperature information dtc obtained by converting the amplified head temperature signal ATC, which is input at the rise of the enable signal EN1, into the digital signal, and outputs the generated digital temperature information dtc to the control circuit 500. The A/D converter 530 may be enabled to operate when the enable signal EN1 falls. In this case, the A/D converter 530 outputs, to the control circuit 500, the digital temperature information dtc obtained by converting the amplified head temperature signal ATC, which is input at the fall of the enable signal EN1, into the digital signal.

The amplification circuit 550 receives the unit temperature signal TH output by the temperature detection circuit 28. The amplification circuit 520 amplifies a voltage value of the input unit temperature signal TH to generate and output an amplified unit temperature signal ATH.

The A/D converter 560 receives the amplified unit temperature signal ATH output by the amplification circuit 520 and an enable signal EN2 output by the control circuit 500. The A/D converter 560 acquires a voltage value of the amplified unit temperature signal ATH at a timing at which the enable signal EN2 for enabling the operation of the A/D converter 560 is input, generates a digital signal according to the acquired voltage value, and outputs the generated signal as digital temperature information dth to the control circuit 500. That is, the A/D converter 560 generates the digital temperature information dth corresponding to the temperature detected by the temperature detection circuit 28 at the timing at which the enable signal EN2 for enabling the operation thereof is input, and outputs the generated digital temperature information dth to the control circuit 500.

The following description will be made on the assumption that the A/D converter 560 is enabled to operate when the enable signal EN2 rises. That is, the description will be made on the assumption that the A/D converter 560 generates the digital temperature information dth obtained by converting the amplified unit temperature signal ATH, which is input at the rise of the enable signal EN2, into the digital signal, and outputs the generated digital temperature information dth to the control circuit 500. The A/D converter 560 may be enabled to operate when the enable signal EN2 falls. In this case, the A/D converter 560 outputs, to the control circuit 500, the digital temperature information dth obtained by converting the amplified unit temperature signal ATH, which is input at the fall of the enable signal EN2, into the digital signal.

The comparison circuit 580 receives the drive signal COM. The comparison circuit 580 compares the voltage value of the input drive signal COM with a predetermined voltage value, and outputs a comparison result signal Vcr whose logic level changes according to a comparison result.

The timing control circuit 590 receives the comparison result signal Vcr output by the comparison circuit 580, and the clock signal CK output by the control circuit 500. The timing control circuit 590 acquires a logic level of the comparison result signal Vcr in synchronization with the clock signal CK, and generates a timing control signal Tgi having a logic level according to the acquired logic level of the comparison result signal Vcr. The timing control circuit 590 outputs the generated timing control signal Tgi to the control circuit 500.

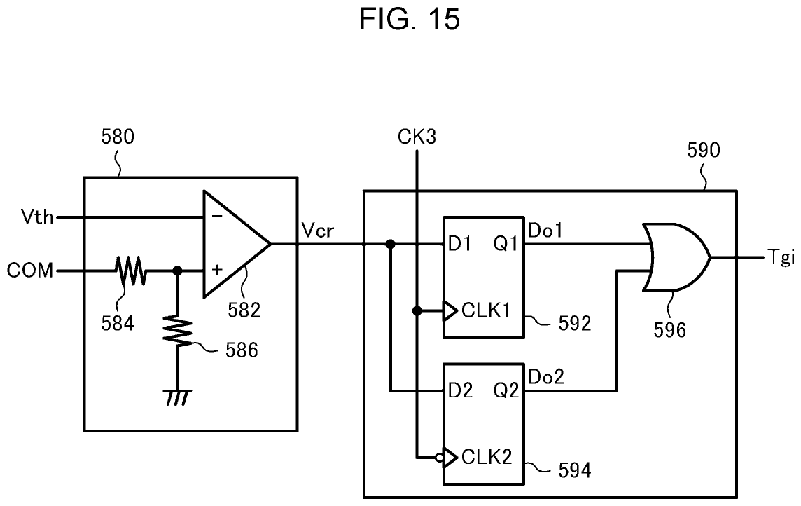

Here, details of the comparison circuit 580 and the timing control circuit 590 will be described. FIG. 15 is a diagram showing an example of configurations of the comparison circuit 580 and the timing control circuit 590.

The comparison circuit 580 includes a comparator 582 and resistors 584 and 586. The drive signal COM is input to one end of the resistor 584. The other end of the resistor 584 is electrically coupled to one end of the resistor 586. The ground potential is supplied to the other end of the resistor 586. A coupling point between the other end of the resistor 584 and one end of the resistor 586 is electrically coupled to a + side input end of the comparator 582. Further, a threshold voltage signal Vth is input to a − side input end of the comparator 582. The comparator 582 generates the comparison result signal Vcr that is at an H level when a voltage value of the + side input end is higher than a voltage value of the − side input end, and is at an L level when the voltage value of the + side input end is lower than the voltage value of the − side input end, and outputs the generated comparison result signal Vcr from an output end of the comparator 582.

In the comparison circuit 580 configured as described above, the resistors 584 and 586 divide the drive signal COM for attenuation. The comparator 582 compares the voltage value of the attenuated drive signal COM with the voltage value of the threshold voltage signal Vth, and outputs the comparison result signal Vcr according to a comparison result. That is, the resistors 584 and 586 prescribe an attenuation factor of the drive signal COM, and thus the voltage value of the drive signal COM is set of which the logic level of the comparison result signal Vcr output by the comparator 582 is switched. The resistance values of the resistors 584 and 586 are set to be the threshold voltage signal Vth when the voltage value of the drive signal COM is the predetermined voltage value. Accordingly, the comparison circuit 580 outputs the comparison result signal Vcr that is at the H level when the voltage value of the drive signal COM is higher than the predetermined voltage value, and is at the L level when the voltage value of the drive signal COM is lower than the predetermined voltage value. In the following description, the predetermined voltage value of the drive signal COM in which the logic level of the comparison result signal Vcr output by the comparison circuit 580 is switched, which is the predetermined voltage value described above, is referred to as a switching voltage Vch.

That is, the comparison circuit 580 compares the voltage value of the drive signal COM with the switching voltage Vch, and outputs the comparison result signal Vcr that is at the H level when the voltage value of the drive signal COM is higher than a voltage value of the switching voltage Vch, and is at the L level when the voltage value of the drive signal COM is lower than the voltage value of the switching voltage Vch. The comparison circuit 580 may include a plurality of resistance elements that divide the threshold voltage signal Vth, in addition to the resistors 584 and 586. Further, when the comparator 582 can be operated without the attenuation of the voltage value of the drive signal COM, the comparison circuit 580 may not include the resistors 584 and 586.

The timing control circuit 590 includes D-type flip-flops 592 and 594 and an OR circuit 596. The comparison result signal Vcr output by the comparison circuit 580 is input to a data input terminal D1 of the D-type flip-flop 592. The clock signal CK output by the control circuit 100 is input to a clock input terminal CLK1 of the D-type flip-flop 592. The D-type flip-flop 592 generates a data signal Do1 according to the logic level of the comparison result signal Vcr input to the data input terminal D1, at the rise of the clock signal CK input to the clock input terminal CLK1, and outputs the generated data signal Do1 from a data output terminal Q1.

The comparison result signal Vcr output by the comparison circuit 580 is input to a data input terminal D2 of the D-type flip-flop 594. A signal in which the logic level of the clock signal CK output by the control circuit 100 is inverted is input to a clock input terminal CLK2 of the D-type flip-flop 594. The D-type flip-flop 594 generates a data signal Do2 according to the logic level of the comparison result signal Vcr input to the data input terminal D2, at the rise of the signal in which the logic level of the clock signal CK input to the clock input terminal CLK2 is inverted and at a fall of the logic level of the clock signal CK output by the control circuit 100, and outputs the generated data signal Do2 from a data output terminal Q2.

The OR circuit 596 receives the data signal Do1 output by the D-type flip-flop 592, and the data signal Do2 output by the D-type flip-flop 594. The OR circuit 596 outputs the timing control signal Tgi that is at the L level when both logic levels of the input data signals Do1 and Do2 are the L level, and is at the H level when at least any one logic level of the input data signals Do1 and Do2 is the H level. The timing control signal Tgi output by the OR circuit 596 is output from the timing control circuit 590 and input to the control circuit 500.

As described above, in the timing control circuit 590 of the present embodiment, the D-type flip-flop 592 outputs the data signal Do1 of H level when the comparison result signal Vcr input to the data input terminal D1 is at the H level at the rise of the clock signal CK, and outputs the data signal Do1 of L level when the comparison result signal Vcr input to the data input terminal D1 is at the L level at the rise of the clock signal CK. On the other hand, the D-type flip-flop 594 outputs the data signal Do2 of H level when the comparison result signal Vcr input to the data input terminal D2 is at the H level at the fall of the clock signal CK, and outputs the data signal Do2 of L level when the comparison result signal Vcr input to the data input terminal D2 is at the L level at the fall of the clock signal CK.

Therefore, the OR circuit 596 generates and outputs the timing control signal Tgi of L level when the comparison result signal Vcr of L level is input to the timing control circuit 590 at the rise of the clock signal CK and the comparison result signal Vcr of L level is input to the timing control circuit 590 at the subsequent fall of the clock signal CK, or when the comparison result signal Vcr of L level is input to the timing control circuit 590 at the fall of the clock signal CK and the comparison result signal Vcr of L level is input to the timing control circuit 590 at the subsequent rise of the clock signal CK. That is, when the comparison result signal Vcr of L level is input to the timing control circuit 590 at both the rise of the clock signal CK and the fall of the clock signal CK, the timing control circuit 590 determines that the comparison result signal Vcr of L level is continuously input for a period from the fall of the clock signal CK to the rise thereof or for a period from the rise of the clock signal CK to the fall thereof, and outputs the timing control signal Tgi of L level.

As described above, the timing control circuit 590 of the present embodiment includes the D-type flip-flop 592 and the D-type flip-flop 594 to which the comparison result signal Vcr is input, and the OR circuit 596 to which the data signal Do1 output from the D-type flip-flop 592 and the data signal Do2 output from the D-type flip-flop 594 are input. The D-type flip-flop 592 outputs the data signal Do1 according to the logic level of the comparison result signal Vcr at the rise of the clock signal CK, the D-type flip-flop 594 outputs the data signal Do2 according to the logic level of the comparison result signal Vcr at the fall of the clock signal CK, and the OR circuit 596 outputs the timing control signal Tgi according to the logic level of the data signal Do1 and the logic level of the data signal Do2.

Returning to FIG. 14, the control circuit 500 outputs the select signal Sel and the clock signal CK in response to the temperature acquisition request signal TD input from the control circuit 100, and outputs the enable signals EN1 and EN2 in response to the temperature acquisition request signal TD input from the control circuit 100 and the timing control signal Tgi input from the timing control circuit 590. Accordingly, the control circuit 500 controls the operation of each configuration included in the temperature information output circuit 26. Further, the control circuit 500 acquires the input digital temperature information dtc, and generates the temperature information signal TI corresponding to the acquired digital temperature information dtc. The control circuit 500 outputs the generated temperature information signal TI from the temperature information output circuit 26. The temperature information signal TI is input to the control circuit 100.

Specifically, the control circuit 500 includes a request analysis section 501, a clock signal output section 502, a temperature information output section 503, a correction value calculation section 504, and a memory control section 505.

The request analysis section 501 acquires and analyzes the temperature acquisition request signal TD input to the control circuit 500. The control circuit 500 generates the select signal Sel according to an analysis result of the request analysis section 501, and outputs the generated select signal Sel to the multiplexer 510. Accordingly, the multiplexer 510 selects the head temperature signal TC selected by the select signal Sel and designated by the temperature acquisition request signal TD. Therefore, the amplification circuit 520 generates the amplified head temperature signal ATC obtained by amplifying the head temperature signal TC designated by the temperature acquisition request signal TD, and outputs the generated amplified head temperature signal ATC to the A/D converter 530.

The clock signal output section 502 divides or multiplies an oscillation signal output by an oscillation circuit (not illustrated) to generate the clock signal CK. The control circuit 500 outputs the generated clock signal CK. In this case, in the clock signal output section 502, according to the analysis result of the temperature acquisition request signal TD in the request analysis section 501, whether or not to generate the clock signal CK may be controlled, or a cycle and frequency of the generated clock signal CK may be controlled. Of course, the clock signal output section 502 may generate the clock signal CK having a predetermined cycle and frequency, regardless of the analysis result of the temperature acquisition request signal TD in the request analysis section 501.

The temperature information output section 503 outputs the enable signal EN1 for enabling the operation of the A/D converter 530, at a timing prescribed by the timing control signal Tgi after the temperature acquisition request signal TD for requesting the acquisition of the temperature of the print head 22 is input to the control circuit 500, the timing at which the logic level of the timing control signal Tgi is the L level after the temperature acquisition request signal TD for requesting the acquisition of the temperature of the print head 22 is input to the control circuit 500 in the present embodiment. Accordingly, the A/D converter 530 acquires the amplified head temperature signal ATC output by the amplification circuit 520 and converts the amplified head temperature signal ATC into the digital signal, and outputs the converted signal as the digital temperature information dtc to the control circuit 500. In this case, the temperature information output section 503 acquires the digital temperature information dtc output by the A/D converter 530, and generates the temperature information signal TI based on the acquired digital temperature information dtc. The control circuit 500 outputs the temperature information signal TI generated by the temperature information output section 503 to the control circuit 100.

That is, the temperature information output section 503 generates the temperature information signal TI that is based on the digital temperature information dtc corresponding to the voltage value of the head temperature signal TC output by the print head 22 and corresponds to the temperature of the print head 22 corresponding to the head temperature signal TC designated by the temperature acquisition request signal TD, at the timing at which the logic level of the timing control signal Tgi is the L level. The control circuit 500 outputs, to the control circuit 100, the temperature information signal TI generated by the temperature information output section 503.

The correction value calculation section 504 calculates a correction value Cv for correcting the temperature information signal TI output by the control circuit 500. For example, the correction value calculation section 504 outputs the enable signal EN1 for enabling the operation of the A/D converter 530 and the enable signal EN2 for enabling the operation of the A/D converter 560, at a predetermined timing after the temperature acquisition request signal TD including a request for calculating the correction value Cv is input from the control circuit 100. Accordingly, the A/D converter 530 acquires the amplified head temperature signal ATC output by the amplification circuit 520, converts the amplified unit temperature signal ATC into the digital signal, and outputs the converted amplified unit temperature signal ATC as the digital temperature information dtc. The A/D converter 560 acquires the amplified unit temperature signal ATH output by the amplification circuit 550, converts the amplified unit temperature signal ATH into the digital signal, and outputs the converted amplified unit temperature signal ATH as the digital temperature information dth. The correction value calculation section 504 acquires the input digital temperature information dtc and digital temperature information dth, and calculates the correction value Cv based on the acquired digital temperature information dtc and digital temperature information dth.

Specifically, when the control circuit 500 receives, from the control circuit 100, the temperature acquisition request signal TD including the request for calculating the correction value Cv corresponding to the print head 22, the request analysis section 501 outputs the select signal Sel for selecting the corresponding print head 22. Thereafter, the correction value calculation section 504 outputs, at substantially the same time, the enable signal EN1 for enabling the operation of the A/D converter 530 and the enable signal EN2 for enabling the operation of the A/D converter 560. Accordingly, the correction value calculation section 504 acquires the digital temperature information dtc and the digital temperature information dth at the same timing. The correction value calculation section 504 calculates the correction value Cv corresponding to the print head 22, based on a difference between the acquired digital temperature information dtc and digital temperature information dth. In this case, the correction value calculation section 504 may individually calculate n correction values Cv corresponding to respective print heads 22-1 to 22-n. The temperature information output section 503 corrects the acquired digital temperature information dtc by using the correction value Cv calculated by the correction value calculation section 504, and generates the temperature information signal TI based on the corrected digital temperature information dtc. Accordingly, the accuracy of the temperature information signal TI output by the control circuit 500 is improved.

The memory control section 505 generates a memory control signal MA for accessing the storage circuit 570, outputs the generated memory control signal MA to the storage circuit 570, and acquires a memory readout signal MR output by the storage circuit 570 in response to the memory control signal MA. Specifically, the storage circuit 570 stores various types of information including the n correction values Cv described above. The memory control section 505 generates the memory control signal MA for storing information such as the correction value Cv and outputs the generated memory control signal MA to the storage circuit 570, and generates the memory control signal MA for reading out the information such as the correction value Cv stored in the storage circuit 570 and outputs the generated memory control signal MA to the storage circuit 570.

The storage circuit 570 stores various types of information including the correction value Cv in response to the input memory control signal MA, reads out the information such as the correction value Cv, and outputs the memory readout signal MR including the readout information to the control circuit 500. Such a storage circuit 570 is configured by including a non-volatile memory such as a ROM or a flash memory.

As described above, the temperature information output circuit 26 includes the control circuit 500 that acquires, from the head temperature signal TC, the digital temperature information dtc corresponding to the temperature of the print head 22, and the timing control circuit 590 that controls the timing at which the control circuit 500 acquires the digital temperature information dtc. Such a temperature information output circuit 26 is preferably configured as, for example, an integrated circuit. Accordingly, a mounting area of the temperature information output circuit 26 in the head unit 20 can be reduced, and as a result, the head unit 20 can be miniaturized. Further, in this case, the integrated circuit configuring the temperature information output circuit 26 is not limited to one, and a plurality of integrated circuits may be employed. Of course, the temperature information output circuit 26 may be configured by including a plurality of circuit elements, in addition to the integrated circuit.

### 7. Detection Timing of Temperature in Temperature Information Output Circuit

In the liquid ejecting apparatus 1 and the head unit 20, physical properties, such as viscosity, of the ink ejected from the nozzle 321 change according to the temperature. Such a change in the physical properties of the ink significantly contributes to the ejection accuracy of the ink. For this reason, in the liquid ejecting apparatus 1 and the head unit 20, a temperature of the ink stored in the pressure chamber 312 communicating with the nozzle 321, which is ejected from the nozzle 321, is acquired, and various signals for controlling the operation of the liquid ejecting apparatus 1 and the head unit 20 are corrected according to the acquired ink temperature to reduce a risk that the ejection accuracy of the ink is decreased even when the ink temperature changes.

In particular, in the liquid ejecting apparatus 1 and the head unit 20 of the present embodiment, the temperature detection circuit 250 that detects the temperature of the print head 22 includes the resistance wiring 401 whose resistance value changes according to the temperature, and the resistance wiring 401 is formed at the vibration plate 350 that is located in the vicinity of the pressure chamber 312 and seals the opening of the pressure chamber substrate 310, which is formed with the pressure chamber 312, on the surface of the vibration plate 350 on the +Z side. Accordingly, the temperature detection circuit 250 can detect the temperature of the ink stored in the pressure chamber 312 in the vicinity of the pressure chamber 312, and thus can detect the temperature of the ink stored in the pressure chamber 312 with higher accuracy. As a result, in the liquid ejecting apparatus 1 and the head unit 20 of the present embodiment, various signals for controlling the operation of the liquid ejecting apparatus 1 and the head unit 20 can be more appropriately corrected according to the temperature of the ink stored in the pressure chamber 312, and thus the risk of the decrease in the ejection accuracy of the ink is further reduced even when the temperature of the ink changes.

On the other hand, since the resistance wiring 401 included in the temperature detection circuit 250 is provided in the vicinity of the pressure chamber 312 in which the ink is stored, the following problems may occur notably.

From the viewpoint of improving quality of an image formed at the medium P, several hundred or more nozzles 321 are disposed at a high density in the print head 22. Therefore, the print head 22 has several hundred or more piezoelectric elements 60 corresponding to several hundred or more nozzles 321, and the several hundred or more piezoelectric elements 60 are disposed at a high density on the vibration plate 350. For this reason, a signal wiring through which the drive signal VOUT supplied to each piezoelectric element 60 propagates in the print head 22 is disposed densely in the vibration plate 350. When the resistance wiring 401 is disposed on such a vibration plate 350, with the disposition of the resistance wiring 401 in the vicinity of the signal wiring through which the drive signal VOUT propagates, there is a high possibility that noise generated by a change in the voltage value of the drive signal VOUT contributes to the resistance wiring 401. When the noise generated by the change in the voltage of the drive signal VOUT contributes to the resistance wiring 401, the accuracy of the head temperature signal TC, which is output by the temperature detection circuit 250 including the resistance wiring 401, is decreased, and thus the detection accuracy of the temperature of the pressure chamber 312 is decreased.

Further, when the piezoelectric element 60 is driven by the drive signal VOUT, the vibration plate 350 disposed with the resistance wiring 401 is displaced according to the drive of the piezoelectric element 60. With the displacement of the vibration plate 350, an impedance of the resistance wiring 401 disposed on the vibration plate 350 may change. When the impedance of the resistance wiring 401 disposed on the vibration plate 350 changes, the accuracy of the head temperature signal TC, which is output by the temperature detection circuit 250 including the resistance wiring 401, is decreased, and the detection accuracy of the temperature of the pressure chamber 312 is decreased.

Furthermore, as described above, with the change in the volume of the pressure chamber 312, the print head 22 applies pressure to the ink, which is accommodated in the pressure chamber 312, to eject the ink from the nozzle 321. In the print head 22 having such a structure, the temperature of the ink stored in the pressure chamber 312 may change instantaneously due to a change in the pressure on the pressure chamber 312 generated when the ink is ejected. When the temperature detection circuit 250 including the resistance wiring 401 detects the temperature change that occurs instantaneously, the temperature change may be superimposed on the head temperature signal TC, which is output by the temperature detection circuit 250, as noise. When the instantaneous temperature change in the temperature of the ink stored in the pressure chamber 312 is superimposed on the head temperature signal TC as noise, the accuracy of the head temperature signal TC output by the temperature detection circuit 250 is decreased, and the detection accuracy of the temperature of the pressure chamber 312 is decreased.

In response to the above problem, in the liquid ejecting apparatus 1 of the present embodiment, the timing control circuit 590 included in the temperature information output circuit 26 controls an optimal acquisition timing of the head temperature signal TC, and thus the accuracy of the digital temperature information dtc based on the head temperature signal TC acquired by the control circuit 500 is improved, and the reliability of the temperature information signal TI based on the digital temperature information dtc is improved. Accordingly, there is a reduced risk of the decrease in the detection accuracy of the temperature of the pressure chamber 312, which is detected by the temperature detection circuit 250.

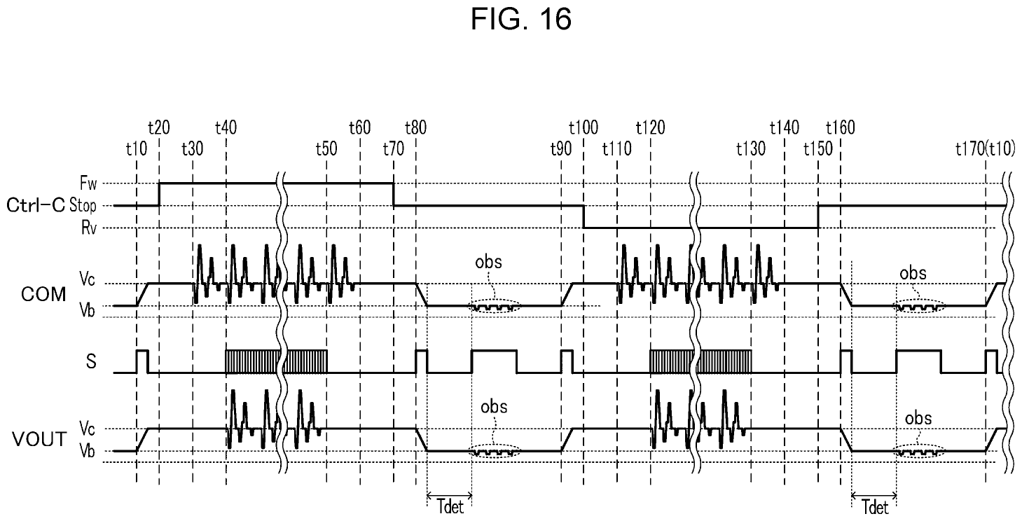

In describing the acquisition timing at which the temperature of the print head 22 is acquired, first, an example of the operation of the liquid ejecting apparatus 1 of the present embodiment will be described, and then an example of the acquisition timing of the temperature of the print head 22 in the operation of the liquid ejecting apparatus 1 will be described. FIG. 16 is a diagram showing an example of the operation of the liquid ejecting apparatus 1 of the present embodiment.

As described above, the liquid ejecting apparatus 1 of the present embodiment is the serial printing-type ink jet printer, and the carriage 21 that reciprocates along the scanning direction is located and stopped on a home position side immediately before at a time point t10. In this case, the control circuit 100 outputs the control signal Ctrl-C for stopping the carriage 21 equipped with the print head 22, and executes an inversion process of inverting the scanning direction of the carriage 21. The drive circuit 50 outputs the drive signal COM whose voltage value is constant at a voltage Vb.

At the time point t10, when the inversion process for the scanning direction of the carriage 21 is completed, the drive circuit 50 starts to output the drive signal COM whose voltage value is constant at the voltage Vc. Further, at the time point t10 at which the drive circuit 50 starts to output the drive signal COM whose voltage value is constant at the voltage Vc, the control circuit 100 outputs the print data signal SI for controlling the logic level of the selection signal S to the H level, in order to control all the selection circuits 230 to be conductive. Accordingly, the drive signal VOUT that is based on the drive signal COM output by the drive circuit 50 and has the voltage value that changes toward the voltage Vc is supplied to the electrode 360 of each of the plurality of piezoelectric elements 60 included in the print head 22.

Thereafter, the voltage value of the drive signal COM output by the drive circuit 50 is constant at the voltage Vc, and thus the drive signal VOUT having the voltage value of the voltage Vc is supplied to the electrode 360 of the piezoelectric element 60. After the drive signal VOUT having the voltage value of the voltage Vc is supplied to the electrode 360 of the piezoelectric element 60, the control circuit 100 outputs the print data signal SI for controlling the logic level of the selection signal S to the L level, in order to control all the selection circuits 230 to be non-conductive. Accordingly, the selection circuit 230 is controlled to be non-conductive. In this case, the voltage value of the electrode 360 of the piezoelectric element 60 is held at the voltage Vc by a capacitance component of the piezoelectric element 60.

At a time point t20 after the voltage value of the drive signal COM output by the drive circuit 50 is constant at the voltage Vc, the control circuit 100 outputs the control signal Ctrl-C for causing the carriage 21 equipped with the print head 22 to move in a forward direction Fw from the home position side toward an opposite home position side. Accordingly, the carriage 21 starts to move in the forward direction Fw along the scanning axis.

At a time point t30 after the carriage 21 starts to move in the forward direction Fw along the scanning axis, the drive circuit 50 starts to output the drive signal COM in which the trapezoidal waveforms Adp, Bdp, and Cdp as shown in FIG. 8 are continuous. At a time point t40 thereafter, with the scanning position of the carriage 21 that reaches a printing region where an image is formed at the medium P, the control circuit 100 outputs the print data signal SI and the clock signal SCK corresponding to the image information signal input from the external device, and the change signal CH and the latch signal LAT corresponding to the scanning position of the carriage 21. Therefore, the selection control circuit 210 outputs the selection signal S having the logic level corresponding to each of the plurality of piezoelectric elements 60, and the selection circuit 230 outputs the drive signal VOUT based on the drive signal COM. Accordingly, an image corresponding to the image information signal is formed at the medium P. That is, a printing process of ejecting the ink to the medium P is executed. The printing region includes a region in which the print head 22 can eject the ink to the medium P, the region in which at least a part of the print head 22 is located facing the medium P along the ejection direction of the ink.

At a time point t50, when the printing process in the forward direction Fw along the scanning axis is completed, the control circuit 100 outputs the print data signal SI for controlling the logic level of the selection signal S to the L level, in order to control all the selection circuits 230 to be non-conductive. Accordingly, the selection circuit 230 is controlled to be non-conductive. In this case, the voltage value of the electrode 360 of the piezoelectric element 60 is held at the voltage Vc by a capacitance component of the piezoelectric element 60. At a time point t60 thereafter, the drive circuit 50 stops the output of the drive signal COM in which the trapezoidal waveforms Adp, Bdp, and Cdp are continuous, and starts to output the drive signal COM whose voltage value is constant at the voltage Vc.

At a time point t70 after the voltage value of the drive signal COM output by the drive circuit 50 is constant at the voltage Vc, with the scanning position of the carriage 21 that reaches a stop region on the opposite home position side, the control circuit 100 outputs the control signal Ctrl-C for stopping the carriage 21 equipped with the print head 22. Accordingly, the carriage 21 is stopped.

At a time point t80 after the carriage 21 is stopped, the drive circuit 50 starts to output the drive signal COM whose voltage value is constant at the voltage Vb. Further, at the time point t80 at which the drive circuit 50 starts to output the drive signal COM whose voltage value is constant at the voltage Vb, the control circuit 100 outputs the print data signal SI for controlling the logic level of the selection signal S to the H level, in order to control all the selection circuits 230 to be conductive. Accordingly, the drive signal VOUT that is based on the drive signal COM output by the drive circuit 50 and has the voltage value that changes toward the voltage Vb is supplied to the electrode 360 of each of the plurality of piezoelectric elements 60 included in the print head 22.

After the voltage value of the drive signal VOUT supplied to the electrode 360 of the piezoelectric element 60 is constant at the voltage Vb, the control circuit 100 outputs the print data signal SI for controlling the logic level of the selection signal S to the L level, in order to control all the selection circuits 230 to be non-conductive. Accordingly, the selection circuit 230 is controlled to be non-conductive. In this case, the voltage value of the electrode 360 of the piezoelectric element 60 is held at the voltage Vb by the capacitance component of the piezoelectric element 60. Thereafter, in the liquid ejecting apparatus 1, the drive circuit 50 stands by for a period until the inversion process of inverting the scanning direction of the carriage 21 in a reverse direction Rv toward the home position side from the opposite home position side is completed, in a state where the output of the drive signal COM whose voltage value is constant at the voltage Vb is continued.

Further, at a predetermined timing within the standby period until the inversion process for the scanning direction of the carriage 21 is completed, the drive circuit 50 outputs the drive signal COM including a micro-vibration waveform obs. In this case, the control circuit 100 outputs the print data signal SI for controlling the logic level of the selection signal S to the H level, in order to control all the selection circuits 230 to be conductive. Accordingly, the drive signal VOUT including the micro-vibration waveform obs is supplied to the electrode 360 of the piezoelectric element 60. As a result, a risk that the ink adheres to the vicinity of the nozzle 321 in the standby period is reduced, and the risk that the ink viscosity is increased in the vicinity of the nozzle 321 is reduced. The drive signal VOUT including the micro-vibration waveform obs is not limited to be supplied to all the piezoelectric elements 60 included in the print head 22, and may be supplied to only a part of the piezoelectric elements 60 included in the print head 22. Further, the micro-vibration by the drive signal VOUT including the micro-vibration waveform obs may be executed a plurality of times in the standby period.

At a time point t90, when the inversion process for the scanning direction of the carriage 21 is completed, the drive circuit 50 starts to output the drive signal COM whose voltage value is constant at the voltage Vc. Further, at the time point t90 at which the drive circuit 50 starts to output the drive signal COM whose voltage value is constant at the voltage Vc, the control circuit 100 outputs the print data signal SI for controlling the logic level of the selection signal S to the H level, in order to control all the selection circuits 230 to be conductive. Accordingly, the drive signal VOUT that is based on the drive signal COM output by the drive circuit 50 and has the voltage value that changes toward the voltage Vc is supplied to the electrode 360 of each of the plurality of piezoelectric elements 60 included in the print head 22.

Thereafter, the voltage value of the drive signal COM output by the drive circuit 50 is constant at the voltage Vc, and thus the drive signal VOUT having the voltage value of the voltage Vc is supplied to the electrode 360 of the piezoelectric element 60. After the drive signal VOUT having the voltage value of the voltage Vc is supplied to the electrode 360 of the piezoelectric element 60, the control circuit 100 outputs the print data signal SI for controlling the logic level of the selection signal S to the L level, in order to control all the selection circuits 230 to be non-conductive. Accordingly, the selection circuit 230 is controlled to be non-conductive. In this case, the voltage value of the electrode 360 of the piezoelectric element 60 is held at the voltage Vc by a capacitance component of the piezoelectric element 60.

At a time point t100 after the voltage value of the drive signal COM output by the drive circuit 50 is constant at the voltage Vc, the control circuit 100 outputs the control signal Ctrl-C for causing the carriage 21 equipped with the print head 22 to move in the reverse direction Rv toward the home position side from the opposite home position side. Accordingly, the carriage 21 starts to move in the reverse direction Rv along the scanning axis.

At a time point t110 after the carriage 21 starts to move in the reverse direction Rv along the scanning axis, the drive circuit 50 starts to output the drive signal COM in which the trapezoidal waveforms Adp, Bdp, and Cdp are continuous. At a time point t120 thereafter, with the scanning position of the carriage 21 that reaches the printing region where an image is formed at the medium P, the control circuit 100 outputs the print data signal SI and the clock signal SCK corresponding to the image information signal input from the external device, and the change signal CH and the latch signal LAT corresponding to the scanning position of the carriage 21. Accordingly, the selection control circuit 210 outputs the selection signal S having the logic level corresponding to each of the plurality of piezoelectric elements 60, and the selection circuit 230 outputs the drive signal VOUT based on the drive signal COM. Accordingly, an image corresponding to the image information signal is formed at the medium P. That is, the printing process is executed.

At a time point t130, when the printing process in the reverse direction Rv along the scanning axis is completed, the control circuit 100 outputs the print data signal SI for controlling the logic level of the selection signal S to the L level, in order to control all the selection circuits 230 to be non-conductive. Accordingly, the selection circuit 230 is controlled to be non-conductive. In this case, the voltage value of the electrode 360 of the piezoelectric element 60 is held at the voltage Vc by a capacitance component of the piezoelectric element 60. At a time point t140 thereafter, the drive circuit 50 stops the output of the drive signal COM in which the trapezoidal waveforms Adp, Bdp, and Cdp are continuous, and starts to output the drive signal COM whose voltage value is constant at the voltage Vc.

At a time point t150 at which the voltage value of the drive signal COM output by the drive circuit 50 is constant at the voltage Vc, with the scanning position of the carriage 21 that reaches the stop region on the home position side, the control circuit 100 outputs the control signal Ctrl-C for stopping the carriage 21 equipped with the print head 22. Accordingly, the carriage 21 is stopped.

At a time point t160 after the carriage 21 is stopped, the drive circuit 50 starts to output the drive signal COM whose voltage value is constant at the voltage Vb. Further, at the time point t160 at which the drive circuit 50 starts to output the drive signal COM whose voltage value is constant at the voltage Vb, the control circuit 100 outputs the print data signal SI for controlling the logic level of the selection signal S to the H level, in order to control all the selection circuits 230 to be conductive. Accordingly, the drive signal VOUT that is based on the drive signal COM output by the drive circuit 50 and has the voltage value that changes toward the voltage Vb is supplied to the electrode 360 of each of the plurality of piezoelectric elements 60 included in the print head 22.

After the voltage value of the drive signal VOUT supplied to the electrode 360 of the piezoelectric element 60 is constant at the voltage Vb, the control circuit 100 outputs the print data signal SI for controlling the logic level of the selection signal S to the L level, in order to control all the selection circuits 230 to be non-conductive. Accordingly, the selection circuit 230 is controlled to be non-conductive. In this case, the voltage value of the electrode 360 of the piezoelectric element 60 is held at the voltage Vb by the capacitance component of the piezoelectric element 60. Thereafter, in the liquid ejecting apparatus 1, the drive circuit 50 stands by for a period until the inversion process of inverting the scanning direction of the carriage 21 in the forward direction Fw toward the opposite home position side from the home position side is completed, in a state where the output of the drive signal COM whose voltage value is constant at the voltage Vb is continued.

Further, at a predetermined timing within the standby period until the inversion process for the scanning direction of the carriage 21 is completed, the drive circuit 50 outputs the drive signal COM including a micro-vibration waveform obs. In this case, the control circuit 100 outputs the print data signal SI for controlling the logic level of the selection signal S to the H level, in order to control all the selection circuits 230 to be conductive. Accordingly, the drive signal VOUT including the micro-vibration waveform obs is supplied to the electrode 360 of the piezoelectric element 60. As a result, a risk that the ink adheres to the vicinity of the nozzle 321 in the standby period is reduced, and the risk that the ink viscosity is increased in the vicinity of the nozzle 321 is reduced. The drive signal VOUT including the micro-vibration waveform obs is not limited to be supplied to all the piezoelectric elements 60 included in the print head 22, and may be supplied to only a part of the piezoelectric elements 60 included in the print head 22. Further, the micro-vibration by the drive signal VOUT including the micro-vibration waveform obs may be executed a plurality of times in the standby period.

At a time point t170 thereafter, when the inversion process for the scanning direction of the carriage 21 is completed, the drive circuit 50 starts to output the signal whose voltage value is constant at the voltage Vc as the drive signal COM. That is, the same operation as the time point t10 described above is started. That is, the liquid ejecting apparatus 1 of the present embodiment repeatedly executes the operation from the time point t10 to the time point t160 described above and transports the medium P along the transport direction to form an image corresponding to the image information signal on the medium P.

In the liquid ejecting apparatus 1 of the present embodiment that operates as described above, the temperature information output circuit 26 acquires the digital temperature information dtc based on the head temperature signal TC corresponding to the temperature of the print head 22, in a period during which the drive circuit 50 outputs the drive signal COM whose voltage value is constant and the drive signal VOUT whose voltage value fluctuates is not supplied to the piezoelectric element 60, generates the temperature information signal TI corresponding to the temperature of the corresponding print head 22 based on the acquired digital temperature information dtc, and outputs the generated temperature information signal TI to the control circuit 100. That is, the temperature information output circuit 26 generates the temperature information signal TI corresponding to the acquired digital temperature information dtc based on the head temperature signal TC corresponding to the temperature of the print head 22, in a period during which the piezoelectric element 60 is not driven by the drive signal VOUT and thus the vibration plate 350 is not displaced, which is the period during which the drive signal VOUT whose voltage value changes is not supplied to the piezoelectric element 60, and outputs the generated temperature information signal TI to the control circuit 100.

Accordingly, there is a reduced risk that noise or the like, caused by the propagation of the drive signal VOUT, the displacement of the vibration plate 350, and the instantaneous temperature change of the temperature of the ink stored in the pressure chamber 312, is superimposed on the head temperature signal TC acquired by the temperature information output circuit 26. As a result, the accuracy of the head temperature signal TC acquired by the temperature information output circuit 26, which is the detection accuracy of the temperature of the pressure chamber 312 to be detected, is improved, and the reliability of the temperature information signal TI output by the temperature information output circuit 26 is improved.

Specifically, in the liquid ejecting apparatus 1 of the present embodiment, since the temperature information output circuit 26 has the configurations shown in FIGS. 14 and 15, the temperature information output circuit 26 acquires the digital temperature information dtc based on the head temperature signal TC corresponding to the temperature of the print head 22, in a detection period Tdet, shown in FIG. 16, that is the period during which the piezoelectric element 60 is not driven by the drive signal VOUT and thus the vibration plate 350 is not displaced, which is the period during which the drive signal VOUT whose voltage value changes is not supplied to the piezoelectric element 60, and outputs the temperature information signal TI corresponding to the acquired digital temperature information dtc.

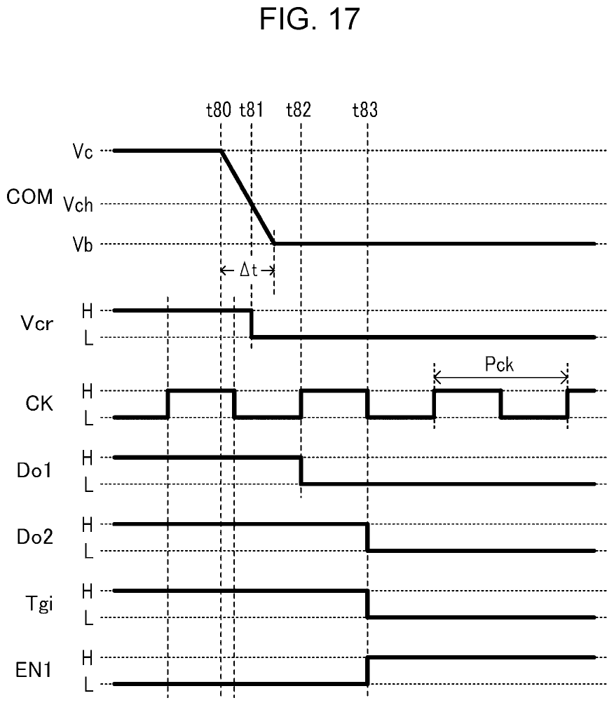

FIG. 17 is a diagram showing an example of the operation of the temperature information output circuit 26 when the digital temperature information dtc is acquired in the detection period Tdet. The time point t80 shown in FIG. 17 indicates the same time point as the time point t80 shown in FIG. 16. As shown in FIG. 17, the voltage value of the switching voltage Vch that switches whether the comparison circuit 580 outputs the comparison result signal Vcr of H level or the comparison result signal Vcr of L level is set to be a voltage value between the voltage Vc, which is the voltage value at the start timing and the end timing of the trapezoidal waveforms Adp, Bdp, and Cdp output as the drive signal COM in the period during which the printing process is executed, and the voltage Vb output as the drive signal COM in the detection period Tdet. That is, the resistance values of the resistors 584 and 586 included in the comparison circuit 580 are set such that the voltage value of the switching voltage Vch is set to be a voltage value between the voltage Vc and the voltage Vb. Further, as shown in FIG. 17, a half cycle of a cycle Pck of the clock signal CK output by the control circuit 500 is set to be longer than a period Δt from the voltage value of the drive signal COM starts to decrease from the voltage Vc at the time point t80 until the voltage thereof is the voltage Vb.

As shown in FIG. 17, immediately before the time point t80, the drive circuit 50 outputs the drive signal COM whose voltage value is constant at the voltage Vc. Therefore, immediately before the time point t80, the comparison circuit 580 outputs the comparison result signal Vcr of H level. That is, immediately before the time point t80, the comparison result signal Vcr of H level is input to the data input terminal D1 of the D-type flip-flop 592 and the data input terminal D2 of the D-type flip-flop 594. For this reason, immediately before the time point t80, the D-type flip-flop 592 outputs a data signal Do1 of H level, and the D-type flip-flop 594 outputs the data signal Do2 of H level. Therefore, immediately before the time point t80, the timing control circuit 590 outputs the timing control signal Tgi of H level to the control circuit 500. In this case, since the control circuit 500 receives the timing control signal Tgi of H level, the control circuit 500 does not output the enable signal EN1 for enabling the operation of the A/D converter 530. For this reason, the A/D converter 530 does not output the digital temperature information dtc in response to the head temperature signal TC, and the control circuit 500 does not generate the temperature information signal TI corresponding to the digital temperature information dtc.

At the time point t80 thereafter, when the movement of the carriage 21 is stopped, the drive circuit 50 starts to output the drive signal COM whose voltage value is constant at the voltage Vb. That is, the voltage value of the drive signal COM output by the drive circuit 50 decreases from the voltage Vc toward the voltage Vb. At a time point t81 at which the voltage value of the drive signal COM output by the drive circuit 50 is less than the switching voltage Vch, the logic level of the comparison result signal Vcr output by the comparison circuit 580 is switched from the H level to the L level. That is, at the time point t81, the comparison result signal Vcr of L level is input to the data input terminal D1 of the D-type flip-flop 592 and the data input terminal D2 of the D-type flip-flop 594.

After the time point t81, at a time point t82 at which the clock signal CK rises, the D-type flip-flop 592 outputs the data signal Do1 of L level according to the comparison result signal Vcr of L level input to the data input terminal D1. After the time point t81, at a time point t83 at which the clock signal CK falls, the D-type flip-flop 594 outputs the data signal Do2 of L level according to the comparison result signal Vcr of L level input to the data input terminal D2. Therefore, at the time point t83, the data signal Do1 of L level and the data signal Do2 of L level are input to the OR circuit 596. As a result, the OR circuit 596 generates the timing control signal Tgi of L level, and the timing control circuit 590 outputs the generated timing control signal Tgi of L level to the control circuit 500.

With the input of the timing control signal Tgi of L level, the control circuit 500 outputs the enable signal EN1 for enabling the operation of the A/D converter 530. The A/D converter 530 outputs the digital temperature information dtc in response to the head temperature signal TC with the input of the enable signal EN1 for enabling the operation thereof, and the control circuit 500 acquires the digital temperature information dtc output by the A/D converter 530. The control circuit 500 generates the temperature information signal TI corresponding to the acquired digital temperature information dtc. That is, the temperature information output circuit 26 acquires the digital temperature information dtc based on the head temperature signal TC corresponding to the temperature of the print head 22, and outputs the temperature information signal TI corresponding to the acquired digital temperature information dtc to the control circuit 100.

In this case, the half cycle of the cycle Pck of the clock signal CK output by the control circuit 500 is set to be longer than the period Δt until the voltage value of the drive signal COM decreases from the voltage Vc to the voltage Vb. Thus, at the time point t83 at which the control circuit 500 acquires the digital temperature information dtc, which is the timing at which the timing control circuit 590 outputs the timing control signal Tgi of L level to the control circuit 500, the voltage value of the drive signal COM output by the drive circuit 50 is constant at the voltage Vb. Therefore, the drive signal VOUT whose voltage value fluctuates is not supplied to the piezoelectric element 60. Accordingly, at the time point t83, there is a reduced risk that noise or the like, caused by the propagation of the drive signal VOUT, the displacement of the vibration plate 350, and the instantaneous temperature change of the temperature of the ink stored in the pressure chamber 312, is superimposed on the head temperature signal TC acquired by the temperature information output circuit 26. As a result, the accuracy of the head temperature signal TC acquired by the temperature information output circuit 26, which is the detection accuracy of the temperature of the pressure chamber 312 to be detected, is improved, and the reliability of the temperature information signal TI output by the temperature information output circuit 26 is improved.

As described above, in the liquid ejecting apparatus 1 of the present embodiment, the timing control circuit 590 included in the temperature information output circuit 26 determines whether or not the voltage value of the drive signal COM is constant, and controls, based on a determination result, the timing at which the control circuit 500 acquires the digital temperature information dtc. Specifically, the timing control circuit 590 of the present embodiment determines that the voltage value of the drive signal COM is constant when the voltage value of the drive signal COM is less than the switching voltage Vch for a predetermined time, and outputs the timing control signal Tgi of L level for controlling the control circuit 500 to acquire the digital temperature information dtc. A time equal to or longer than the half cycle of the cycle Pck of the clock signal CK corresponds to the predetermined time in the present embodiment. Accordingly, without a complicated configuration of the temperature information output circuit 26, there is a reduced risk that noise or the like, caused by the propagation of the drive signal VOUT, the displacement of the vibration plate 350, and the instantaneous temperature change of the temperature of the ink stored in the pressure chamber 312, is superimposed on the head temperature signal TC acquired by the temperature information output circuit 26. As a result, the accuracy of the head temperature signal TC acquired by the temperature information output circuit 26, which is the detection accuracy of the temperature of the pressure chamber 312 to be detected, is improved, and the reliability of the temperature information signal TI output by the temperature information output circuit 26 is improved.

In FIG. 17, the description is made on the assumption that the clock signal CK rises at the time point t82 and falls at the time point t83. However, the clock signal CK may fall at the time point t82 and rise at the time point t83. In this case, at the time point t82 at which the clock signal CK falls, the D-type flip-flop 594 outputs the data signal Do2 of L level according to the comparison result signal Vcr of L level input to the data input terminal D2. At the time point t83 at which the clock signal CK rises, the D-type flip-flop 592 outputs the data signal Do1 of L level according to the comparison result signal Vcr of L level input to the data input terminal D1. Thereafter, the operation shown in FIG. 17 is executed.

On the other hand, a voltage amplitude of the drive signal COM in which the trapezoidal waveforms Adp, Bdp, and Cdp are continuous changes according to the ejection amount or viscosity of the ejected ink. For this reason, when there is a possibility that the lowest voltage value of the drive signal COM in which the trapezoidal waveforms Adp, Bdp, and Cdp are continuous is less than the switching voltage Vch, and when the lowest voltage value of the drive signal COM in which the trapezoidal waveforms Adp, Bdp, and Cdp are continuous is less than the switching voltage Vch, there is a risk that the temperature information output circuit 26 erroneously determines that the voltage value of the drive signal COM is constant and thus the acquisition accuracy of the digital temperature information dtc, based on the head temperature signal TC in the temperature information output circuit 26, is decreased.

In response to the above problem, in the liquid ejecting apparatus 1 of the present embodiment, with the optimal setting of the cycle of the clock signal CK for acquiring the comparison result signal Vcr by the D-type flip-flops 592 and 594, in the period during which the drive circuit 50 outputs the drive signal COM in which the trapezoidal waveforms Adp, Bdp, and Cdp are continuous, there is a reduced risk that the temperature information output circuit 26 erroneously determines that the voltage value of the drive signal COM is constant, and there is a reduced risk of the decrease in the acquisition accuracy of the digital temperature information dtc, based on the head temperature signal TC in the temperature information output circuit 26.

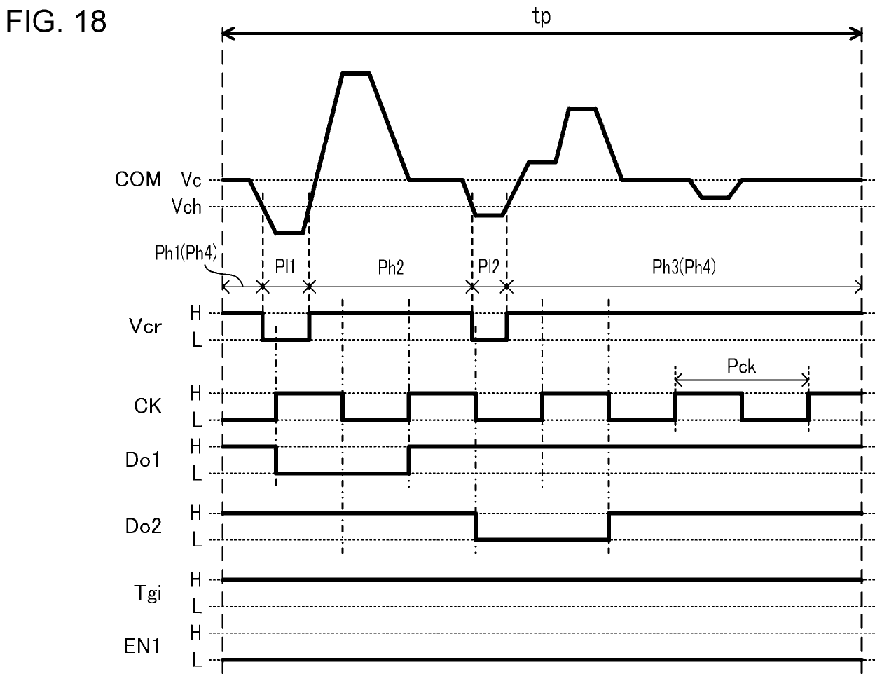

FIG. 18 is a diagram showing an example of the operation of the temperature information output circuit 26 in a part of the period during which the drive circuit 50 outputs the drive signal COM in which the trapezoidal waveforms Adp, Bdp, and Cdp are continuous, for example, the period from the time point t30 to the time point t60 shown in FIG. 16.

In FIG. 18, periods Ph1, Ph2, and Ph3 during which the voltage value of the drive signal COM in which the trapezoidal waveforms Adp, Bdp, and Cdp are continuous exceeds the switching voltage Vch are described together with periods Pl1 and Pl2 during which the voltage value of the drive signal COM in which the trapezoidal waveforms Adp, Bdp, and Cdp are continuous is less than the switching voltage Vch. The period Ph1 shown in FIG. 18 is continuous with the period Ph3 in the immediately preceding cycle tp. For this reason, the period Ph1 and the period Ph3 can be regarded as one continuous period. In the following description, the period during which the period Ph1 and the period Ph3 are continuous is referred to as a period Ph4.

As described above, with the continuous input of the comparison result signal Vcr of L level in the rise of the clock signal CK and the fall thereof, the temperature information output circuit 26 determines that the voltage value of the drive signal COM is constant. For this reason, in the period during which the drive circuit 50 outputs the drive signal COM in which the trapezoidal waveforms Adp, Bdp, and Cdp are continuous, with the continuous input of the comparison result signal Vcr of L level in the rise of the clock signal CK and the fall thereof, the temperature information output circuit 26 erroneously determines that the voltage value of the drive signal COM is constant.

For this reason, in the liquid ejecting apparatus 1 of the present embodiment, as shown in FIG. 18, the control circuit 500 controls the cycle Pck of the clock signal CK such that the rise of the clock signal CK and the fall thereof are not continuously included in the periods Pl1 and Pl2. Specifically, the control circuit 500 controls the cycle Pck of the clock signal CK such that the half cycle of the cycle Pck of the clock signal CK is longer than both periods Pl1 and Pl2. In other words, the control circuit 500 controls the frequency of the clock signal CK such that a length of the half cycle of the clock signal CK is longer than a maximum value of a time at which the comparison circuit 580 outputs the comparison result signal Vcr of L level, in the cycle tp which is one cycle of the drive signal COM.

Accordingly, there is a reduced risk that the rise of the clock signal CK and the fall thereof are continuously included in the period Pl1 or the period Pl2. As a result, in the period during which the drive circuit 50 outputs the drive signal COM in which the trapezoidal waveforms Adp, Bdp, and Cdp are continuous, there is a reduced risk that the temperature information output circuit 26 determines that the voltage value of the drive signal COM is constant.

Furthermore, in the liquid ejecting apparatus 1 of the present embodiment, as shown in FIG. 18, the control circuit 500 controls the frequency of the clock signal CK such that the length of the half cycle of the clock signal CK is shorter than a minimum value of a time at which the comparison circuit 580 outputs the comparison result signal Vcr of H level, in the cycle tp which is one cycle of the drive signal COM.

Accordingly, in each of the period Ph2 and the period Ph4, the rise or fall of the clock signal CK occurs at least once. Therefore, when the rise of the clock signal CK occurs in one of the period Pl1 and the period Pl2, the fall of the clock signal CK following the rise occurs in the period Ph2 and the period Ph4, and may not occur in the other of the period Pl1 or the period Pl2. Similarly, when the fall of the clock signal CK occurs in the period Pl1 or the period Pl2, the rise of the clock signal CK following the fall occurs in the period Ph2 and the period Ph4, and may not occur in the period Pl1 or the period Pl2. Therefore, there is a further reduced risk that the rise of the clock signal CK and the fall thereof are continuously included in the period Pl1 or the period Pl2. As a result, in the period during which the drive circuit 50 outputs the drive signal COM in which the trapezoidal waveforms Adp, Bdp, and Cdp are continuous, there is a reduced risk that the temperature information output circuit 26 determines that the voltage value of the drive signal COM is constant.

The control circuit 500 is an example of a temperature information acquisition circuit, and the digital temperature information dtc acquired by the control circuit 500 is an example of temperature information. Further, the D-type flip-flop 592 is an example of a first D-type flip-flop circuit, the data signal Do1 output by the D-type flip-flop 592 is an example of a first data signal, the D-type flip-flop 594 is an example of a second D-type flip-flop circuit, and the data signal Do2 output by the D-type flip-flop 594 is an example of a second data signal. Further, the OR circuit 596 is an example of a logic element. Further, the voltage value of the drive signal COM in the comparison circuit 580 is an example of a determination threshold value. Further, the switching voltage Vch is an example of a predetermined threshold value and a threshold voltage value, and the H level of the logic levels of the comparison result signal Vcr, which is output by the comparison circuit 580, is an example of a first logic level, and the L level thereof is an example of a second logic level. Further, the clock signal CK is an example of a clock signal. The electrode 360 is an example of a first electrode, the electrode 380 is an example of a second electrode, the direction along the Z axis in the print head 22 is an example of a lamination direction, the +Z side in the print head 22 is an example of one side, the −Z side in the print head 22 is an example of the other side, and the resistance wiring 401 is an example of a temperature detection section.

### 8. Action and Effect

In the liquid ejecting apparatus 1 and the head unit 20 of the present embodiment configured as described above, the temperature information output circuit 26 acquiring the head temperature signal TC, which corresponds to the temperature of the print head 22, includes the control circuit 500 that acquires, from the head temperature signal TC, the digital temperature information dtc corresponding to the temperature of the print head 22, and the timing control circuit 590 that controls the timing at which the control circuit 500 acquires the digital temperature information dtc. The timing control circuit 590 determines whether or not the voltage value of the drive signal COM is constant, and controls, based on the determination result, the acquisition timing at which the control circuit 500 acquires the digital temperature information dtc. Accordingly, there is a reduced risk that noise or the like, caused by the propagation of the drive signal VOUT, the displacement of the vibration plate 350, and the instantaneous temperature change of the temperature of the ink stored in the pressure chamber 312, is superimposed on the head temperature signal TC acquired by the control circuit 500. As a result, the accuracy of the head temperature signal TC acquired by the temperature information output circuit 26, which is the detection accuracy of the temperature of the pressure chamber 312 to be detected, is improved, and the reliability of the temperature information signal TI output by the temperature information output circuit 26 is improved. That is, the detection accuracy of the temperature of the print head 22 is improved.

Further, in the liquid ejecting apparatus 1 and the head unit 20 of the present embodiment, even when the print head 22 included in the head unit 20 includes: the piezoelectric element 60 that includes the electrode 360, the electrode 380, and the piezoelectric body 370, has the piezoelectric body 370 that is located between the electrode 360 and the electrode 380 in the direction along the Z axis in which the electrode 360, the electrode 380, and the piezoelectric body 370 are laminated, and receives the drive signal COM to be driven; the vibration plate 350 that is located on the +Z side, which is one side of the piezoelectric element 60 in the direction along the Z axis, and is deformed by the drive of the piezoelectric element 60; the pressure chamber substrate 310 that is located on the +Z side, which is one side of the vibration plate 350 in the direction along the Z axis, and provided with the pressure chamber 312 in which the ink is stored and whose volume is changed due to the deformation of the vibration plate 350; the nozzle 321 that ejects the ink according to the change in the volume of the pressure chamber 312; and the resistance wiring 401 that is located on the −Z side, which is the other side of the vibration plate 350 in the direction along the Z axis, and acquires the temperature of the pressure chamber 312 according to the temperature, with the determination by the timing control circuit 590 whether or not the voltage value of the drive signal COM is constant and the control of the acquisition timing of the digital temperature information dtc in the control circuit 500 based on the determination result, there is a reduced risk that noise or the like, caused by the propagation of the drive signal VOUT, the displacement of the vibration plate 350, and the instantaneous temperature change of the temperature of the ink stored in the pressure chamber 312, is superimposed on the head temperature signal TC acquired by the control circuit 500. Therefore, the detection accuracy of the temperature of the print head 22 is further improved.

Further, in the liquid ejecting apparatus 1 and the head unit 20 of the present embodiment, the detection accuracy of the temperature of the print head 22 is improved. Therefore, with the correction of the drive signal COM output by the drive circuit 50 based on the head temperature signal TC, which is the temperature of the print head 22, the ejection accuracy of the ink from the print head 22 can be improved.

### 9. Modification Examples

In the liquid ejecting apparatus 1 of the present embodiment described above, the description is made on the assumption that the comparison circuit 580 compares the voltage value of the drive signal COM with the switching voltage Vch, and outputs the comparison result signal Vcr that is at the H level when the voltage value of the drive signal COM is higher than a voltage value of the switching voltage Vch, and is at the L level when the voltage value of the drive signal COM is lower than the voltage value of the switching voltage Vch. However, the comparison circuit 580 may compare the voltage value of the drive signal COM with the switching voltage Vch, and output the comparison result signal Vcr that is at the L level when the voltage value of the drive signal COM is higher than a voltage value of the switching voltage Vch, and be at the H level when the voltage value of the drive signal COM is lower than the voltage value of the switching voltage Vch. In this case, the timing control circuit 590 has an AND circuit instead of the OR circuit 596, and the control circuit 500 outputs the enable signal EN1 for enabling the operation of the A/D converter 530 with the change in the level of the input timing control signal Tgi from the L level to the H level, and thus the same action and effect as that of the above embodiment is achieved. The AND circuit provided instead of the OR circuit 596 corresponds to another example of the logic element.

Further, in the liquid ejecting apparatus 1 of the present embodiment, the description is made, as an example, with a case where the resistance wiring 401 configuring a part of the temperature detection circuit 250 is formed in the vibration plate 350. However, the temperature detection circuit 250 is not limited to the above configuration, and may detect the temperature of the ink stored in the print head 22, which is the temperature of the print head 22.

The embodiments and the modification examples are described above. However, the present disclosure is not limited to the embodiments, and can be implemented in various forms within the scope not departing from the concept of the present disclosure. For example, the above embodiments can also be combined with each other as appropriate.

The present disclosure includes substantially the same configurations (for example, configurations having the same functions, methods, and results, or configurations having the same objects and effects) as the configurations described in the embodiments. Further, the present disclosure includes configurations in which non-essential parts of the configurations described in the embodiments are replaced. Further, the present disclosure includes configurations that achieve the same action and effect or configurations that can achieve the same object as those of the configurations described in the embodiments. Further, the present disclosure includes configurations in which a known technique is added to the configurations described in the embodiments.

The following contents are derived from the above embodiments.

According to an aspect, there is provided a liquid ejecting apparatus including:
a drive circuit that outputs a drive signal;
a print head that ejects a liquid by receiving the drive signal; and
a temperature information output circuit that acquires a head temperature signal corresponding to a temperature of the print head, in which
the temperature information output circuit includes
   a temperature information acquisition circuit that acquires, from the head temperature signal, temperature information corresponding to the temperature of the print head, and
   a timing control circuit that controls a timing at which the temperature information acquisition circuit acquires the temperature information, and
the timing control circuit determines whether or not a voltage value of the drive signal is constant, and outputs a timing control signal for controlling, based on a determination result, the timing at which the temperature information acquisition circuit acquires the temperature information.

In the liquid ejecting apparatus, the timing control circuit determines whether or not the voltage value of the drive signal is constant, and outputs the timing control signal for controlling, based on the determination result, the timing at which the temperature information acquisition circuit acquires the temperature information. Therefore, the temperature information acquisition circuit can acquire, from the head temperature signal, the temperature information corresponding to the temperature of the print head, in a period during which the voltage value of the drive signal is constant. Accordingly, there is a reduced risk that noise or the like, from the print head, caused by an operation of ejecting the liquid is superimposed on the temperature information, at the timing at which the temperature information acquisition circuit acquires, from the head temperature signal, the temperature information corresponding to the temperature of the print head. As a result, the accuracy of the temperature information acquired by the temperature information acquisition circuit is improved.

In the liquid ejecting apparatus according to the aspect, the timing control circuit may control the temperature information acquisition circuit to acquire the temperature information when the voltage value of the drive signal is determined to be constant.

In the liquid ejecting apparatus, the temperature information acquisition circuit can acquire, from the head temperature signal, the temperature information corresponding to the temperature of the print head, in the period during which the voltage value of the drive signal is constant. Accordingly, there is a reduced risk that noise or the like, from the print head, caused by an operation of ejecting the liquid is superimposed on the temperature information, at the timing at which the temperature information acquisition circuit acquires, from the head temperature signal, the temperature information corresponding to the temperature of the print head. As a result, the accuracy of the temperature information acquired by the temperature information acquisition circuit is improved.

In the liquid ejecting apparatus according to the aspect,
the timing control circuit may determine that the voltage value of the drive signal is constant when the voltage value of the drive signal is less than a predetermined threshold value for a predetermined time.

In the liquid ejecting apparatus, the temperature information acquisition circuit can acquire, from the head temperature signal, the temperature information corresponding to the temperature of the print head, in the period during which the voltage value of the drive signal is constant. Accordingly, there is a reduced risk that noise or the like, from the print head, caused by an operation of ejecting the liquid is superimposed on the temperature information, at the timing at which the temperature information acquisition circuit acquires, from the head temperature signal, the temperature information corresponding to the temperature of the print head. As a result, the accuracy of the temperature information acquired by the temperature information acquisition circuit is improved.

In the liquid ejecting apparatus according to the aspect,
the temperature information output circuit may include
   a comparison circuit that compares the voltage value of the drive signal with a threshold voltage value, and outputs a comparison result signal that is at a first logic level when the voltage value of the drive signal is higher than the threshold voltage value and is at a second logic level when the voltage value of the drive signal is lower than the threshold voltage value,
the timing control circuit may include
   a first D-type flip-flop circuit and a second D-type flip-flop circuit to which the comparison result signal is input, and
   a logic element to which a first data signal output by the first D-type flip-flop circuit and a second data signal output by the second D-type flip-flop circuit are input,
the first D-type flip-flop circuit may output the first data signal according to a logic level of the comparison result signal at a rise of a clock signal,
the second D-type flip-flop circuit may output the second data signal according to a logic level of the comparison result signal at a fall of the clock signal, and
the logic element may output the timing control signal according to a logic level of the first data signal and a logic level of the second data signal.

In this liquid ejecting apparatus, whether or not the voltage value of the drive signal is constant can be determined in a simple configuration.

In the liquid ejecting apparatus according to the aspect,
a length of a half cycle of the clock signal may be longer than a maximum value of a time at which the comparison circuit outputs a signal of the second logic level, in a period of one cycle of the drive signal.

In the liquid ejecting apparatus, there is a reduced risk that the temperature information acquisition circuit acquires, from the head temperature signal, the temperature information corresponding to the temperature of the print head, in a period during which the voltage value of the drive signal changes. Accordingly, there is a further reduced risk that noise or the like, from the print head, caused by an operation of ejecting the liquid is superimposed on the temperature information, at the timing at which the temperature information acquisition circuit acquires, from the head temperature signal, the temperature information corresponding to the temperature of the print head. As a result, the accuracy of the temperature information acquired by the temperature information acquisition circuit is improved.

In the liquid ejecting apparatus according to the aspect,
a length of a half cycle of the clock signal may be shorter than a minimum value of a time at which the comparison circuit outputs a signal of the first logic level, in a period of one cycle of the drive signal.

In the liquid ejecting apparatus, there is a reduced risk that the temperature information acquisition circuit acquires, from the head temperature signal, the temperature information corresponding to the temperature of the print head, in a period during which the voltage value of the drive signal changes. Accordingly, there is a further reduced risk that noise or the like, from the print head, caused by an operation of ejecting the liquid is superimposed on the temperature information, at the timing at which the temperature information acquisition circuit acquires, from the head temperature signal, the temperature information corresponding to the temperature of the print head. As a result, the accuracy of the temperature information acquired by the temperature information acquisition circuit is improved.

In the liquid ejecting apparatus according to the aspect,
the print head may include
   a piezoelectric element that includes a first electrode, a second electrode, and a piezoelectric body, the piezoelectric body being located between the first electrode and the second electrode in a lamination direction in which the first electrode, the second electrode, and the piezoelectric body are laminated, and that receives the drive signal to be driven,
   a vibration plate that is located on one side of the piezoelectric element in the lamination direction, and is deformed by the drive of the piezoelectric element,
   a pressure chamber substrate that is located on one side of the vibration plate in the lamination direction, and provided with a pressure chamber in which a liquid is stored and a volume of the pressure chamber is changed due to the deformation of the vibration plate,
   a nozzle that ejects the liquid according to the change in the volume of the pressure chamber, and
   a temperature detection section that is located on another side of the vibration plate in the lamination direction, and outputs the head temperature signal corresponding to a temperature of the pressure chamber.

In the liquid ejecting apparatus, even when the temperature detection section is located in the vicinity of the pressure chamber, the temperature information acquisition circuit can acquire, from the head temperature signal, the temperature information corresponding to the temperature of the print head, in the period during which the voltage value of the drive signal is constant. Therefore, the temperature information can be acquired with high accuracy.

In the liquid ejecting apparatus according to the aspect,
the drive circuit may output the drive signal corrected based on the head temperature signal.

In the liquid ejecting apparatus, since the acquisition accuracy of the temperature information in the temperature information acquisition circuit can be improved, the correction accuracy of the drive signal corrected based on the temperature information is improved, and thus the ejection accuracy of the liquid from the print head is improved.

According to an aspect, there is provided a head unit including:
a print head that ejects a liquid by receiving a drive signal; and
a temperature information output circuit that acquires a head temperature signal corresponding to a temperature of the print head, in which
the temperature information output circuit includes
   a temperature information acquisition circuit that acquires, from the head temperature signal, temperature information corresponding to the temperature of the print head, and
   a timing control circuit that controls a timing at which the temperature information acquisition circuit acquires the temperature information, and
the timing control circuit determines whether or not a voltage value of the drive signal is constant, and outputs a timing control signal for controlling, based on a determination result, the timing at which the temperature information acquisition circuit acquires the temperature information.

In the head unit, the timing control circuit determines whether or not the voltage value of the drive signal is constant, and outputs the timing control signal for controlling, based on the determination result, the timing at which the temperature information acquisition circuit acquires the temperature information. Therefore, the temperature information acquisition circuit can acquire, from the head temperature signal, the temperature information corresponding to the temperature of the print head, in a period during which the voltage value of the drive signal is constant. Accordingly, there is a reduced risk that noise or the like, from the print head, caused by an operation of ejecting the liquid is superimposed on the temperature information, at the timing at which the temperature information acquisition circuit acquires, from the head temperature signal, the temperature information corresponding to the temperature of the print head. As a result, the accuracy of the temperature information acquired by the temperature information acquisition circuit is improved.

In the head unit according to the aspect,
the timing control circuit may control the temperature information acquisition circuit to acquire the temperature information when the voltage value of the drive signal is determined to be constant.

In the head unit, the temperature information acquisition circuit can acquire, from the head temperature signal, the temperature information corresponding to the temperature of the print head, in the period during which the voltage value of the drive signal is constant. Accordingly, there is a reduced risk that noise or the like, from the print head, caused by an operation of ejecting the liquid is superimposed on the temperature information, at the timing at which the temperature information acquisition circuit acquires, from the head temperature signal, the temperature information corresponding to the temperature of the print head. As a result, the accuracy of the temperature information acquired by the temperature information acquisition circuit is improved.

In the head unit according to the aspect,
the timing control circuit may determine that the voltage value of the drive signal is constant when the voltage value of the drive signal is less than a predetermined threshold value for a predetermined time.

In the head unit, the temperature information acquisition circuit can acquire, from the head temperature signal, the temperature information corresponding to the temperature of the print head, in the period during which the voltage value of the drive signal is constant. Accordingly, there is a reduced risk that noise or the like, from the print head, caused by an operation of ejecting the liquid is superimposed on the temperature information, at the timing at which the temperature information acquisition circuit acquires, from the head temperature signal, the temperature information corresponding to the temperature of the print head. As a result, the accuracy of the temperature information acquired by the temperature information acquisition circuit is improved.

In the head unit according to the aspect,
the temperature information output circuit may include
   a comparison circuit that compares the voltage value of the drive signal with a threshold voltage value, and outputs a comparison result signal that is at a first logic level when the voltage value of the drive signal is higher than the threshold voltage value and is at a second logic level when the voltage value of the drive signal is lower than the threshold voltage value,
the timing control circuit may include
   a first D-type flip-flop circuit and a second D-type flip-flop circuit to which the comparison result signal is input, and
   a logic element to which a first data signal output by the first D-type flip-flop circuit and a second data signal output by the second D-type flip-flop circuit are input,
the first D-type flip-flop circuit may output the first data signal according to a logic level of the comparison result signal at a rise of a clock signal,
the second D-type flip-flop circuit may output the second data signal according to a logic level of the comparison result signal at a fall of the clock signal, and
the logic element may output the timing control signal according to a logic level of the first data signal and a logic level of the second data signal.

In the head unit, whether or not the voltage value of the drive signal is constant can be determined in a simple configuration.

In the head unit according to the aspect,
a length of a half cycle of the clock signal may be longer than a maximum value of a time at which the comparison circuit outputs a signal of the second logic level, in a period of one cycle of the drive signal. In the head unit, there is a reduced risk that the temperature information acquisition circuit acquires, from the head temperature signal, the temperature information corresponding to the temperature of the print head, in a period during which the voltage value of the drive signal changes. Accordingly, there is a further reduced risk that noise or the like, from the print head, caused by an operation of ejecting the liquid is superimposed on the temperature information, at the timing at which the temperature information acquisition circuit acquires, from the head temperature signal, the temperature information corresponding to the temperature of the print head. As a result, the accuracy of the temperature information acquired by the temperature information acquisition circuit is improved.

In the head unit according to the aspect,
a length of a half cycle of the clock signal may be shorter than a minimum value of a time at which the comparison circuit outputs a signal of the first logic level, in a period of one cycle of the drive signal.

In the head unit, there is a reduced risk that the temperature information acquisition circuit acquires, from the head temperature signal, the temperature information corresponding to the temperature of the print head, in a period during which the voltage value of the drive signal changes. Accordingly, there is a further reduced risk that noise or the like, from the print head, caused by an operation of ejecting the liquid is superimposed on the temperature information, at the timing at which the temperature information acquisition circuit acquires, from the head temperature signal, the temperature information corresponding to the temperature of the print head. As a result, the accuracy of the temperature information acquired by the temperature information acquisition circuit is improved.

In the head unit according to the aspect,
the print head may include
   a piezoelectric element that includes a first electrode, a second electrode, and a piezoelectric body, the piezoelectric body being located between the first electrode and the second electrode in a lamination direction in which the first electrode, the second electrode, and the piezoelectric body are laminated, and that receives the drive signal to be driven,
   a vibration plate that is located on one side of the piezoelectric element in the lamination direction, and is deformed by the drive of the piezoelectric element,
   a pressure chamber substrate that is located on one side of the vibration plate in the lamination direction, and provided with a pressure chamber in which a liquid is stored and a volume of the pressure chamber is changed due to the deformation of the vibration plate,
   a nozzle that ejects the liquid according to the change in the volume of the pressure chamber, and
   a temperature detection section that is located on another side of the vibration plate in the lamination direction and that outputs the head temperature signal corresponding to a temperature of the pressure chamber.

In the head unit, even when the temperature detection section is located in the vicinity of the pressure chamber, the temperature information acquisition circuit can acquire, from the head temperature signal, the temperature information corresponding to the temperature of the print head, in the period during which the voltage value of the drive signal is constant. Therefore, the temperature information can be acquired with high accuracy.

In the head unit according to the aspect,
the drive signal may be corrected based on the head temperature signal.

In the head unit, since the acquisition accuracy of the temperature information in the temperature information acquisition circuit can be improved, the correction accuracy of the drive signal corrected based on the temperature information is improved, and thus the ejection accuracy of the liquid from the print head is improved.

What is claimed is:

1. A liquid ejecting apparatus comprising:
a drive circuit that outputs a drive signal;
a print head that ejects a liquid by receiving the drive signal; and
a temperature information output circuit that acquires a head temperature signal corresponding to a temperature of the print head, wherein
the temperature information output circuit includes
a temperature information acquisition circuit that acquires, from the head temperature signal, temperature information corresponding to the temperature of the print head, and
a timing control circuit that controls a timing at which the temperature information acquisition circuit acquires the temperature information, and
the timing control circuit determines whether or not a voltage value of the drive signal is constant, and outputs a timing control signal for controlling, based on a determination result, the timing at which the temperature information acquisition circuit acquires the temperature information.

2. The liquid ejecting apparatus according to claim 1,
wherein the timing control circuit controls the temperature information acquisition circuit to acquire the temperature information when the voltage value of the drive signal is determined to be constant.

3. The liquid ejecting apparatus according to claim 2, wherein
the timing control circuit determines that the voltage value of the drive signal is constant when the voltage value of the drive signal is less than a predetermined threshold value for a predetermined time.

4. The liquid ejecting apparatus according to claim 1, wherein
the temperature information output circuit includes
a comparison circuit that compares the voltage value of the drive signal with a threshold voltage value, and outputs a comparison result signal that is at a first logic level when the voltage value of the drive signal is higher than the threshold voltage value and is at a second logic level when the voltage value of the drive signal is lower than the threshold voltage value,
the timing control circuit includes
a first D-type flip-flop circuit and a second D-type flip-flop circuit to which the comparison result signal is input, and
a logic element to which a first data signal output by the first D-type flip-flop circuit and a second data signal output by the second D-type flip-flop circuit are input,
the first D-type flip-flop circuit outputs the first data signal according to a logic level of the comparison result signal at a rise of a clock signal,
the second D-type flip-flop circuit outputs the second data signal according to a logic level of the comparison result signal at a fall of the clock signal, and
the logic element outputs the timing control signal according to a logic level of the first data signal and a logic level of the second data signal.

5. The liquid ejecting apparatus according to claim 4, wherein
a length of a half cycle of the clock signal is longer than a maximum value of a time at which the comparison circuit outputs a signal of the second logic level, in a period of one cycle of the drive signal.

6. The liquid ejecting apparatus according to claim 4, wherein
a length of a half cycle of the clock signal is shorter than a minimum value of a time at which the comparison circuit outputs a signal of the first logic level, in a period of one cycle of the drive signal.

7. The liquid ejecting apparatus according to claim 1, wherein
the print head includes
a piezoelectric element that includes a first electrode, a second electrode, and a piezoelectric body, the piezoelectric body being located between the first electrode and the second electrode in a lamination direction in which the first electrode, the second electrode, and the piezoelectric body are laminated, and that receives the drive signal to be driven,
a vibration plate that is located on one side of the piezoelectric element in the lamination direction, and is deformed by the drive of the piezoelectric element,
a pressure chamber substrate that is located on one side of the vibration plate in the lamination direction, and provided with a pressure chamber in which a liquid is stored and a volume of the pressure chamber is changed due to the deformation of the vibration plate,
a nozzle that ejects the liquid according to the change in the volume of the pressure chamber, and
a temperature detection section that is located on another side of the vibration plate in the lamination direction and that outputs the head temperature signal corresponding to a temperature of the pressure chamber.

8. The liquid ejecting apparatus according to claim 1, wherein
the drive circuit outputs the drive signal corrected based on the head temperature signal.

9. A head unit comprising:
a print head that ejects a liquid by receiving a drive signal; and
a temperature information output circuit that acquires a head temperature signal corresponding to a temperature of the print head, wherein
the temperature information output circuit includes
a temperature information acquisition circuit that acquires, from the head temperature signal, temperature information corresponding to the temperature of the print head, and
a timing control circuit that controls a timing at which the temperature information acquisition circuit acquires the temperature information, and
the timing control circuit determines whether or not a voltage value of the drive signal is constant, and outputs a timing control signal for controlling, based on a determination result, the timing at which the temperature information acquisition circuit acquires the temperature information.

10. The head unit according to claim 9, wherein
the timing control circuit controls the temperature information acquisition circuit to acquire the temperature information when the voltage value of the drive signal is determined to be constant.

11. The head unit according to claim 10, wherein
the timing control circuit determines that the voltage value of the drive signal is constant when the voltage value of the drive signal is less than a predetermined threshold value for a predetermined time.

12. The head unit according to claim 9, wherein
the temperature information output circuit includes
a comparison circuit that compares the voltage value of the drive signal with a threshold voltage value, and outputs a comparison result signal that is at a first logic level when the voltage value of the drive signal is higher than the threshold voltage value and is at a second logic level when the voltage value of the drive signal is lower than the threshold voltage value,
the timing control circuit includes
a first D-type flip-flop circuit and a second D-type flip-flop circuit to which the comparison result signal is input, and
a logic element to which a first data signal output by the first D-type flip-flop circuit and a second data signal output by the second D-type flip-flop circuit are input,
the first D-type flip-flop circuit outputs the first data signal according to a logic level of the comparison result signal at a rise of a clock signal,
the second D-type flip-flop circuit outputs the second data signal according to a logic level of the comparison result signal at a fall of the clock signal, and
the logic element outputs the timing control signal according to a logic level of the first data signal and a logic level of the second data signal.

13. The head unit according to claim 12, wherein
a length of a half cycle of the clock signal is longer than a maximum value of a time at which the comparison circuit outputs a signal of the second logic level, in a period of one cycle of the drive signal.

14. The head unit according to claim 12, wherein
a length of a half cycle of the clock signal is shorter than a minimum value of a time at which the comparison circuit outputs a signal of the first logic level, in a period of one cycle of the drive signal.

15. The head unit according to claim 9, wherein
the print head includes
a piezoelectric element that includes a first electrode, a second electrode, and a piezoelectric body, the piezoelectric body being located between the first electrode and the second electrode in a lamination direction in which the first electrode, the second electrode, and the piezoelectric body are laminated, and that receives the drive signal to be driven,
a vibration plate that is located on one side of the piezoelectric element in the lamination direction, and is deformed by the drive of the piezoelectric element,
a pressure chamber substrate that is located on one side of the vibration plate in the lamination direction, and provided with a pressure chamber in which a liquid is stored and a volume of the pressure chamber is changed due to the deformation of the vibration plate,
a nozzle that ejects the liquid according to the change in the volume of the pressure chamber, and
a temperature detection section that is located on another side of the vibration plate in the lamination direction, and outputs the head temperature signal corresponding to a temperature of the pressure chamber.

16. The head unit according to claim 9, wherein
the drive signal is corrected based on the head temperature signal.
